(19) United States
(12) Patent Application Publication
(10) Pub. No.: US 2024/0255103 A1
(43) Pub. Date: Aug. 1, 2024

(54) SCALABLE THERMAL ENERGY RECYCLING FOR CRYOGENIC SYSTEMS

(71) Applicant: International Business Machines Corporation, Armonk, NY (US)

(72) Inventors: Stephen W. Bedell, Wappingers Falls, NY (US); Patryk Gumann, Tarrytown, NY (US); William Thomas Spratt, Croton-on-Hudson, NY (US); David Zarsky, Bethlehem, PA (US); Gilbert Bauer, Peekskill, NY (US)

(21) Appl. No.: 18/161,483

(22) Filed: Jan. 30, 2023

(51) Int. Cl. F17C 3/08

(52) U.S. Cl. CPC F17C 3/085; F17C 2203/0391; F17C 2223/0161; F17C 2260/046; F17C 2265/04

(57) ABSTRACT

Systems and techniques that facilitate scalable thermal energy recycling for cryogenic systems are provided. In various embodiments, a system can comprise at least one cryostat. In various aspects, the system can further comprise a thermal battery coupled to the at least one cryostat by a thermal exchange system. In various instances, the thermal battery can be configured to store thermal energy extracted from the at least one cryostat or to supply thermal energy to the at least one cryostat.

### BACKGROUND

The subject disclosure relates to cryogenic systems, and more specifically to scalable thermal energy recycling for cryogenic systems.

Because a quantum processor depends upon cryogenic temperatures for proper operation, such quantum processor can be implemented within a cryostat. During a cool-down cycle, the cryostat can consume inputted electrical energy to transfer thermal energy out of the cryostat. During an active warm-up cycle, the cryostat can consume inputted electrical energy to transfer thermal energy into the cryostat. During a passive warm-up cycle, the cryostat can avoid consuming inputted electrical energy, at the expense of a lengthy warm-up time. In any case, the energy or time spent cooling down or warming up the cryostat can be considered as costs of operating the cryostat. As quantum processors and the cryostats that house them scale up, such costs can excessively accumulate, which can be undesirable.

Accordingly, systems or techniques that can address one or more of these technical problems can be desirable.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, methods, or apparatuses that can facilitate scalable thermal energy recycling for cryogenic systems are described.

According to one or more embodiments, a system is provided. In various aspects, the system can comprise at least one cryostat. In various instances, the system can comprise a thermal battery coupled to the at least one cryostat by a thermal exchange system. In various cases, the thermal battery can be configured to store thermal energy extracted from the at least one cryostat or to supply thermal energy to the at least one cryostat. In various aspects, the thermal battery can be thermally insulated, by a vacuum chamber, by a heat shield, or by underground installation, from an ambient environment surrounding the at least one cryostat. In various instances, the thermal battery can comprise a plurality of thermally insulated cells that can be respectively coupled to the at least one cryostat via a plurality of actuatable flow valves of the thermal exchange system.

According to one or more embodiments, a method is provided. In various aspects, the method can comprise opening, via one or more controllers, one or more first flow valves of thermal exchange plumbing, where the thermal exchange plumbing can couple a cryostat to a thermal battery, and where a first cell of the thermal battery can be thermally integrated with the cryostat when the one or more first flow valves are open. In various instances, the method can further comprise circulating, via a pump and through the thermal exchange plumbing, a thermal exchange fluid between the cryostat and the first cell, until a temperature of the cryostat is within a threshold margin of a temperature of the first cell.

According to one or more embodiments, a device is provided. In various aspects, the device can comprise a thermal battery suspended in a vacuum chamber. In various instances, the device can further comprise thermal exchange plumbing that can couple the thermal battery to an exterior of the vacuum chamber.

Various other details of various embodiments described herein are provided in the following clauses:
CLAUSE 1: A system, comprising: at least one cryostat; and a thermal battery coupled to the at least one cryostat by a thermal exchange system, wherein the thermal battery is configured to store thermal energy extracted from the at least one cryostat or to supply thermal energy to the at least one cryostat.
CLAUSE 2: The system of any preceding clause, wherein the thermal battery is thermally insulated, by a vacuum chamber, by a heat shield, or by underground installation, from an ambient environment surrounding the at least one cryostat.
CLAUSE 3: The system of any preceding clause, wherein the at least one cryostat is colder than the thermal battery, and wherein the thermal exchange system is configured to circulate a thermal exchange fluid between the at least one cryostat and the thermal battery, which circulation is configured to cause the thermal exchange fluid to absorb energy from the thermal battery and to deposit the energy to the at least one cryostat.
CLAUSE 4: The system of any preceding clause, wherein the at least one cryostat is below five Kelvin.
CLAUSE 5: The system of any preceding clause, wherein the at least one cryostat is warmer than the thermal battery, and wherein the thermal exchange system is configured to circulate a thermal exchange fluid between the at least one cryostat and the thermal battery, which circulation is configured to cause the thermal exchange fluid to absorb energy from the at least one cryostat and to deposit the energy to the thermal battery.
CLAUSE 6: The system of any preceding clause, wherein the at least one cryostat is at room temperature.
CLAUSE 7: The system of any preceding clause, wherein the thermal battery comprises a plurality of thermally insulated cells that are respectively coupled to the at least one cryostat via a plurality of actuatable flow valves of the thermal exchange system.
CLAUSE 8: The system of any preceding clause, wherein the plurality of actuatable flow valves are configured to operate alternately, such that at most one of the plurality of thermally insulated cells is thermally coupled to the at least one cryostat at a time.
CLAUSE 9: The system of any preceding clause, wherein two or more of the plurality of thermally insulated cells have different masses or different heat capacities than each other.
CLAUSE 10: The system of any preceding clause, wherein the cryostat houses a quantum processor.

In various aspects, any combination or combinations of any of clauses 1-10 can be implemented.
CLAUSE 11: A method, comprising: opening, via one or more controllers, one or more first flow valves of thermal exchange plumbing, wherein the thermal exchange plumbing couples a cryostat to a thermal battery, and wherein a first cell of the thermal battery is thermally integrated with the cryostat when the one or more first flow valves are open; and circulating, via a pump and through the thermal exchange plumbing, a thermal exchange fluid between the cryostat and the first cell, until a temperature of the cryostat is within a threshold margin of a temperature of the first cell.
CLAUSE 12: The method of any preceding clause, further comprising: in response to a determination that the temperature of the cryostat is within the threshold margin of the temperature of the first cell, ceasing, via the pump, circulation of the thermal exchange fluid between the cryostat and the first cell; and closing, via the one or more controllers, the one or more first flow valves of the thermal exchange plumbing, wherein the first cell of the thermal battery is thermally isolated from the cryostat when the one or more first flow valves are closed.
CLAUSE 13: The method of any preceding clause, further comprising: in response to closing the one or more first flow valves, opening, via the one or more controllers, one or more second flow valves of the thermal exchange plumbing, wherein a second cell of the thermal battery is thermally integrated with the cryostat when the one or more second flow valves are open; and circulating, via the pump and through the thermal exchange plumbing, the thermal exchange fluid between the cryostat and the second cell.
CLAUSE 14: The method of any preceding clause, wherein the first cell and the second cell have different masses or different heat capacities.
CLAUSE 15: The method of any preceding clause, wherein the temperature of the cryostat is below the temperature of the first cell, such that circulation of the thermal exchange fluid between the cryostat and the first cell causes the cryostat to be heated and the first cell to be cooled.
CLAUSE 16: The method of any preceding clause, wherein the temperature of the cryostat is above the temperature of the first cell, such that circulation of the thermal exchange fluid between the cryostat and the first cell causes the cryostat to be cooled and the first cell to be heated.

In various aspects, any combination or combinations of any of clauses 11-16 can be implemented.
CLAUSE 17: A device, comprising: a thermal battery suspended in a vacuum chamber; and thermal exchange plumbing that couples the thermal battery to an exterior of the vacuum chamber.
CLAUSE 18: The device of any preceding clause, wherein the thermal battery comprises a spherical mass of copper.
CLAUSE 19: The device of any preceding clause, wherein the thermal battery comprises at least two cells, and wherein the at least two cells have different masses or different heat capacities than each other.
CLAUSE 20: The device of any preceding clause, wherein the thermal exchange plumbing comprises vacuum-insulated pipes.

In various aspects, any combination or combinations of any of clauses 17-20 can be implemented.

### DESCRIPTION OF THE DRAWINGS

FIG. 1 illustrates a structural diagram of an example, non-limiting system that facilitates scalable thermal energy recycling for cryogenic systems in accordance with one or more embodiments described herein.

FIG. 2 illustrates an example, non-limiting block diagram showing how pre-warming via a thermal battery can affect the temperature of a cryostat in accordance with one or more embodiments described herein.

FIG. 3 illustrates an example, non-limiting block diagram showing how pre-cooling via a thermal battery can affect the temperature of a cryostat in accordance with one or more embodiments described herein.

FIG. 4 illustrates a structural diagram of an example, non-limiting embodiment of a thermal battery suspended in a vacuum chamber that facilitates scalable thermal energy recycling for cryogenic systems in accordance with one or more embodiments described herein.

FIG. 5 illustrates a flow diagram of an example, non-limiting method that facilitates scalable thermal energy recycling for cryogenic systems in accordance with one or more embodiments described herein.

FIG. 6 illustrates a structural diagram of an example, non-limiting embodiment of a multi-cell thermal battery that facilitates scalable thermal energy recycling for cryogenic systems in accordance with one or more embodiments described herein.

FIG. 7 illustrates a flow diagram of an example, non-limiting method involving a multi-cell thermal battery that facilitates scalable thermal energy recycling for cryogenic systems in accordance with one or more embodiments described herein.

FIG. 8 illustrates a flow diagram of an example, non-limiting method that facilitates scalable thermal energy recycling for cryogenic systems in accordance with one or more embodiments described herein.

### DETAILED DESCRIPTION

The following detailed description is merely illustrative and is not intended to limit embodiments or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

A quantum processor can be any suitable device that can implement or otherwise comprise any suitable number of any suitable types of qubit architectures. Various non-limiting examples of such qubit architectures can include quantum dots, spin qubits, or superconducting qubits (e.g., transmons, or other qubits made up of Josephson junctions). Generally, a quantum processor cannot achieve proper operation or functionality above cryogenic temperatures. Accordingly, to achieve proper operation, such quantum processor can be implemented within a cryostat.

A cryostat can be any suitable device that can cool (e.g., via any suitable cryogenic refrigeration techniques) an interior region or enclosure of the cryostat to cryogenic temperatures. During a cool-down cycle, the cryostat can consume inputted electrical energy so as to transfer thermal energy out of the interior region or enclosure of the cryostat (e.g., so as to cool the interior region or enclosure of the cryostat from room temperature to cryogenic temperatures, such that whatever quantum processors are housed in the cryostat can be operated). For example, the cryostat can comprise any suitable number of cryogenic compressors that can circulate a cryogen through a refrigeration cycle, and such cryogenic compressors can be driven by inputted electrical energy. Similarly, during an active warm-up cycle, the cryostat can consume inputted electrical energy so as to transfer thermal energy into the interior region or enclosure of the cryostat (e.g., so as to heat the interior region or enclosure of the cryostat from cryogenic temperatures to room temperature, such that whatever quantum processors are housed in the cryostat can be repaired, inspected, or upgraded). For example, the cryostat can comprise any suitable number of heaters (e.g., heating coils) that can supply heat to the interior region or enclosure of the cryostat, and such heaters can be driven by inputted electrical energy. In contrast, during a passive warm-up cycle, the cryostat can avoid consuming inputted electrical energy, at the expense of a lengthy warm-up time. For example, a passive warm-up cycle can include deactivating the cryostat and waiting for the cryostat to naturally warm to room temperature as a result of ambient environmental heat transfer. However, because the cryostat can be well thermally insulated, such a passive warm-up cycle can take orders of magnitude more time than an active warm-up cycle.

Moreover, as the inventors of various embodiments described herein recognized, the electrical energy used to remove the heat from the cryostat can be lost to the ambient environment surrounding the cryostat during warm-up. For research-laboratory-scale cryostats, this loss may be considered as acceptable. However, for large-scale or industrial-scale cryogenic quantum computing server spaces with multiple large cryostats, such loss can be considered as unacceptable.

In other words, the energy or time spent cooling-down or warming-up the cryostat can be considered as costs of operating the cryostat. As quantum processors and the cryostats that house them scale up in size, such costs can excessively accumulate, which can be undesirable. For example, a cryostat that houses quantum processors comprising tens or dozens of qubit architectures can require much less energy and much less time to cool-down or warm-up than a cryostat that instead houses quantum processors comprising hundreds, thousands, or even millions of qubit architectures.

Accordingly, systems or techniques that can address one or more of these technical problems can be desirable.

Various embodiments described herein can address one or more of these technical problems. In particular, various embodiments described herein can provide systems or techniques that can facilitate scalable thermal energy recycling for cryogenic systems. More specifically, the inventors of various embodiments described herein realized that, when existing techniques are implemented, the electrical energy consumed by a cryostat and the thermal energy manipulated by the cryostat during cool-down cycles or warm-up cycles are eventually lost as waste heat to an ambient environment surrounding the cryostat. Furthermore, the present inventors recognized that, because the ambient environment can be considered as an expansive thermal reservoir that experiences no or at most negligible (e.g., below any suitable threshold margin) temperature changes in response to such waste heat, such waste heat can be considered as being unreclaimable. As described herein, the present inventors devised various techniques for recycling thermal energy associated with the cryostat, so that such lost or unreclaimable waste heat can be reduced, and so that the time or electrical energy spent during cool-down cycles or warm-up cycles can be commensurately reduced.

For example, suppose that the interior region or enclosure of the cryostat begins at room temperature. In such case, it can be desired to perform a cool-down cycle on the cryostat. When the cool-down cycle is performed according to existing techniques, electrical energy can be consumed by cryogenic compressors of the cryostat to remove thermal energy from the interior region or enclosure, and both such consumed electrical energy and such removed thermal energy can be rejected to the ambient environment where they are effectively lost or unreclaimable. After such cool-down cycle, the interior region or enclosure of the cryostat can be at cryogenic temperatures. Accordingly, it can eventually be desired to perform a warm-up cycle on the cryostat. When the warm-up cycle (which can be active or passive) is performed according to existing techniques, new thermal energy can be injected into the interior region or enclosure, such that the interior region or enclosure is once again at room temperature. At some point in time, it can be desired to perform another cool-down cycle. However, during such another cool-down cycle, the new thermal energy that was injected during the warm-up cycle can be removed by the cryogenic compressors and can be rejected to the ambient environment where it becomes lost or unreclaimable. In this way, cool-down cycles and warm-up cycles can be considered as undoing or otherwise wasting the thermal work performed by each other. Moreover, alternately iterating between cool-down cycles and warm-up cycles according to existing techniques can increase a total amount of lost or unreclaimable waste heat, which can correspondingly increase a total amount of time or electrical energy spent during such alternate iterations.

To ameliorate this technical problem, the present inventors devised various techniques, as described herein, that can reclaim or otherwise recycle at least some of the thermal energy that is manipulated by the cryostat.

Indeed, various embodiments described herein can include coupling a thermal battery to a cryostat. In various aspects, there can exist a temperature difference between the thermal battery and the cryostat. Accordingly, a thermal exchange fluid can be circulated or cycled between the thermal battery and the cryostat, to facilitate heat transfer. For example, if the thermal battery is at a higher temperature than the cryostat, circulation of the thermal exchange fluid can cause thermal energy (e.g., heat) to be absorbed from the thermal battery and to be rejected to the cryostat. This can correspondingly cause the temperature of the thermal battery to fall and the temperature of the cryostat to rise. Such heat transfer can be considered as pre-warming the cryostat prior to the performance of a warm-up cycle by the cryostat. As another example, if the thermal battery is instead at a lower temperature than the cryostat, circulation of the thermal exchange fluid can cause thermal energy to be absorbed from the cryostat and to be rejected to the thermal battery. This can correspondingly cause the temperature of the thermal battery to rise and the temperature of the cryostat to fall. Such heat transfer can be considered as pre-cooling the cryostat prior to the performance of a cool-down cycle by the cryostat.

In other words, the thermal battery can, in some cases, be considered as supplying thermal energy to the cryostat or can, in other cases, be considered as siphoning thermal energy from the cryostat. In either case, note that the temperature of the thermal battery (unlike the temperature of the ambient environment) can non-negligibly change (e.g., can change by more than any suitable threshold margin) as it supplies thermal energy to or siphons thermal energy from the cryostat. Due to such non-negligible changes in temperature, the thermal battery can be considered as being able to store or recycle at least some thermal work that was performed during a previous cool-down cycle or during a previous warm-up cycle.

Accordingly, when the thermal battery is implemented as described herein, at least some thermal work that would otherwise have been lost to the ambient environment can instead be recycled so as to perform pre-cooling or pre-warming of the cryostat. As described herein, such recycled thermal work can reduce: the total amount of electrical energy needed to complete a subsequent cool-down cycle of the cryostat; the total amount of electrical energy needed to complete a subsequent active warm-up cycle of the cryostat; or the total amount of time needed to complete a subsequent passive warm-up cycle of the cryostat. In other words, various embodiments described herein can reduce the total amount of time or the total amount of input energy required to operate the cryostat.

More specifically, various embodiments described herein can comprise a cryostat, a thermal battery, and a thermal exchange system. In various aspects, the cryostat can house or otherwise contain any suitable number of any suitable types of quantum processors.

In various instances, the thermal battery can be any suitable tangible object whose temperature can non-negligibly change in response to receiving thermal energy from or supplying thermal energy to the cryostat. As a non-limiting example, the thermal battery can be a chunk of metal (e.g., copper) having any suitable mass, size, or shape. In various cases, the thermal battery can be thermally isolated from an ambient environment surrounding the cryostat. As a non-limiting example, the thermal battery can be vacuum-insulated by being suspended (e.g., in chandelier fashion) within any suitable vacuum chamber. Such vacuum-insulation can help to reduce or prevent heat transfer from occurring between the thermal battery and the ambient environment. Moreover, in various aspects, interior or exterior surfaces of the vacuum chamber can be lined with any suitable thermal barriers (e.g., heat shield materials, thermal insulation materials), which can further help to reduce or prevent heat transfer from occurring between the thermal battery and the ambient environment. Furthermore, in various instances, the vacuum chamber can be installed underground, which can even further help to reduce or prevent heat transfer from occurring between the thermal battery and the ambient environment.

In any case, the thermal battery can be coupled to the cryostat via the thermal exchange system. In various aspects, the thermal exchange system can include a pump and can also include piping through which the pump can propel or circulate a working fluid (e.g., Helium-3 (³He) or Helium-4 (⁴He)). In various cases, the piping and the pump, like the thermal battery, can be thermally isolated (e.g., via vacuum-insulation, via thermal barriers such as heat shield materials or thermal insulation materials, via underground installation) from the ambient environment. In various instances, the piping can run through (e.g., inside) the thermal battery from an inlet end of the thermal battery to an outlet end of the thermal battery. In various cases, the piping can further run from the outlet end of the thermal battery to an inlet end of the cryostat. In various aspects, the piping can further run through (e.g., inside) the cryostat from the inlet end of the cryostat to an outlet end of the cryostat. In various instances, the piping can further run from the outlet end of the cryostat to the inlet end of the thermal battery. Accordingly, the piping can be considered as forming a closed loop between the cryostat and the thermal battery.

In various aspects, the pump of the thermal exchange system can propel or circulate the working fluid through the closed loop formed by the piping of the thermal exchange system. When the temperature of the cryostat is different from the temperature of the thermal battery (and when the average temperature of the working fluid is between such two temperatures), propulsion or circulation of the working fluid can cause heat transfer to occur between the thermal battery and the cryostat, and such heat transfer can cease when the pump ceases to propel or circulate the working fluid.

For example, suppose that the thermal battery begins at a lower temperature than the cryostat. In such case, propulsion or circulation of the working fluid can cause the working fluid to be at a higher temperature than the thermal battery as the working fluid passes through the thermal battery, and such propulsion or circulation can likewise cause the working fluid to be at a lower temperature than the cryostat as the working fluid passes through the cryostat. Accordingly, the working fluid can absorb thermal energy as it passes through the cryostat, thereby reducing the temperature of the cryostat, and the working fluid can reject that thermal energy as it passes through the thermal battery, thereby increasing the temperature of the thermal battery. At some point in time, propulsion or circulation of the working fluid can cause the temperature of the cryostat to become equal to (or to otherwise come within any suitable threshold margin of) the temperature of the thermal battery. At such point in time, heat transfer from the cryostat to the thermal battery can cease or otherwise be reduced, notwithstanding any further propulsion or circulation of the working fluid. Thus, at such point in time, the pump of the thermal exchange system can cease propelling or circulating the working fluid, and cryogenic compressors of the cryostat can be activated to further reduce the temperature of the cryostat. In other words, when the thermal battery begins at a lower temperature than the cryostat, propulsion or circulation of the working fluid can be considered as performing pre-cooling on the cryostat, and the cryostat can perform a remainder of a cool-down cycle after such pre-cooling.

As another example, suppose that the thermal battery instead begins at a higher temperature than the cryostat. In such case, propulsion or circulation of the working fluid can cause the working fluid to be at a lower temperature than the thermal battery as the working fluid passes through the thermal battery, and such propulsion or circulation can likewise cause the working fluid to be at a higher temperature than the cryostat as the working fluid passes through the cryostat. Accordingly, the working fluid can absorb thermal energy as it passes through the thermal battery, thereby reducing the temperature of the thermal battery, and the working fluid can reject that thermal energy as it passes through the cryostat, thereby increasing the temperature of the cryostat. Just as above, propulsion or circulation of the working fluid can, at some point in time, cause the temperature of the cryostat to become equal to (or to otherwise come within any suitable threshold margin of) the temperature of the thermal battery. At such point in time, heat transfer from the thermal battery to the cryostat can cease or otherwise be reduced, notwithstanding any further propulsion or circulation of the working fluid. Thus, at such point in time, the pump of the thermal exchange system can cease propelling or circulating the working fluid, and heating coils of the cryostat can be activated to further increase the temperature of the cryostat. In other words, when the thermal battery begins at a higher temperature than the cryostat, propulsion or circulation of the working fluid can be considered as performing pre-warming on the cryostat, and the cryostat can perform a remainder of a warm-up cycle after such pre-warming.

In any case, note that, because the thermal battery and the piping of the thermal exchange system can be thermally isolated from the ambient environment, no or at most negligible heat transfer can occur between the thermal battery and the ambient environment when the working fluid is not being propelled or circulated through the piping. Therefore, when the thermal battery is used to perform pre-warming on the cryostat, such pre-warming can cause the temperature of the thermal battery to decrease, and the lack of non-negligible heat transfer between the thermal battery and the ambient environment can cause the temperature of the thermal battery to remain decreased until it is desired to perform a subsequent cool-down cycle on the cryostat. At that time, the thermal battery can be used to perform pre-cooling on the cryostat, and the subsequent cool-down cycle can then be conducted. Likewise, when the thermal battery is used to perform pre-cooling on the cryostat, such pre-cooling can cause the temperature of the thermal battery to increase, and the lack of non-negligible heat transfer between the thermal battery and the ambient environment can cause the temperature of the thermal battery to remain increased until it is desired to perform a subsequent warm-up cycle on the cryostat. At that time, the thermal battery can be used to perform pre-warming on the cryostat, and the subsequent warm-up cycle can then be conducted.

Accordingly, pre-cooling as described herein can cause thermal energy to be transferred out of the cryostat and to be stored in the thermal battery, which can reduce a total amount of time or inputted electrical energy needed to complete a cool-down cycle of the cryostat (e.g., the pump of the thermal exchange system can consume less electrical energy per unit time than the cryogenic compressors of the cryostat). Conversely, pre-warming as described herein can cause such stored thermal energy to be subsequently transferred out of the thermal battery and back into the cryostat, which can reduce a total amount of time or inputted electrical energy needed to complete a warm-up cycle of the cryostat (e.g., the pump of the thermal exchange system can consume less electrical energy per unit time than the heating coils of the cryostat; the pump of the thermal exchange system can heat the cryostat more quickly than can passive warm-up). In other words, the thermal battery can be considered as storing or recycling at least some thermal work that was previously performed by the cryostat during a preceding warm-up or cool-down cycle, so that an amount of thermal work that the cryostat performs in a succeeding cool-down or warm-up cycle can be reduced. Thus, implementation of the thermal battery as described herein can help to reduce costs (e.g., time or inputted electrical energy) associated with operating the cryostat.

Thus far, the thermal battery has been described as exhibiting a single-stage structure (e.g., as being one, contiguous chunk of metal). However, this is a mere non-limiting example. In various aspects, the thermal battery can instead exhibit a multi-stage structure. In such cases, the thermal battery can be made up of a plurality of thermal cells, where each thermal cell can be a distinct chunk of metal having any suitable mass, size, shape, or chemical composition, and where the plurality of thermal cells can be thermally isolated from each other. For example, each of such plurality of thermal cells can be thermally insulated by a respective vacuum chamber, by respective thermal barriers, or by respective underground installation.

In various aspects, the piping of the thermal exchange system can comprise a plurality of actuatable valves that can respectively correspond to the plurality of thermal cells. When whichever actuatable valves that correspond to a given thermal cell are open, the working fluid can flow through that given thermal cell. In such case, that given thermal cell can be considered as being thermally integrated with the cryostat. In other words, non-negligible heat transfer can occur between the cryostat and that given thermal cell in response to the pump propelling or circulating the working fluid, when the actuatable valves corresponding to that given thermal cell are open. Conversely, when the actuatable valves corresponding to that given thermal cell are closed, the working fluid can be unable to flow through that given thermal cell. In such case, that given thermal cell can be considered as being thermally isolated from the cryostat. That is, no or at most negligible heat transfer can occur between the cryostat and that given thermal cell in response to the pump propelling or circulating the working fluid, when the actuatable valves corresponding to that given thermal cell are closed.

In various instances, the plurality of actuatable valves can be configured to operate alternately, such that at most one of the plurality of thermal cells can be thermally integrated with the cryostat at any given time. In such case, whichever of the plurality of thermal cells is currently thermally integrated with the cryostat can be used to perform pre-warming or pre-cooling on the cryostat. Moreover, in response to the temperature of the cryostat becoming equal to (or otherwise coming within any suitable threshold margin of) the temperature of that thermal cell, the plurality of actuatable valves can operate so as to thermally isolate that thermal cell from the cryostat and so as to thermally integrate a different one of the plurality of thermal cells with the cryostat. Such different thermal cell can then be used to continue such pre-warming or pre-cooling of the cryostat.

Various embodiments described herein can be employed to solve problems that are highly technical in nature (e.g., to facilitate scalable thermal energy recycling for cryogenic systems), and such embodiments are not abstract, are not mere laws of nature, are not mere natural phenomena, and cannot be performed as a set of mental acts by a human. Instead, various embodiments described herein include tangible thermal-fluid-related structures/architectures or methodologies pertaining to such tangible thermal-fluid-related structures/architectures that can be implemented so as to reduce how much time or electrical energy is consumed by a cryostat during cool-down cycles or warm-up cycles.

Indeed, as mentioned above, when a cryostat operates according to existing techniques, the electrical energy consumed and the thermal energy manipulated by the cryostat during cool-down cycles and warm-up cycles are eventually lost as waste heat to an ambient environment surrounding the cryostat. After all, a warm-up cycle can involve injecting thermal energy into the cryostat, and a cool-down cycle can involve rejecting that thermal energy to the ambient environment where it becomes lost or unreclaimable. In other words, a cool-down cycle can be considered as wasting the thermal work that was performed during a preceding warm-up cycle, and a warm-up cycle can likewise be considered as wasting the thermal work that was performed during a preceding cool-down cycle. Such waste can increase a total amount of time or electrical energy consumed by the cryostat, which can be undesirable.

Various embodiments described herein can address such technical problems. Specifically, systems or techniques described herein can include coupling a thermal battery to the cryostat, where the thermal battery can be thermally isolated (e.g., via vacuum-insulation, via thermal barriers, via underground installation) from the ambient environment surrounding the cryostat. In various aspects, the thermal battery and the cryostat can be at different temperatures (e.g., one at room temperature, the other at cryogenic temperatures). Accordingly, circulating a working fluid (e.g., ³He, ⁴He) through the cryostat and through the thermal battery can cause non-negligible heat transfer to occur between the cryostat and the thermal battery. In cases where the thermal battery is initially cooler than the cryostat, circulating the working fluid can cause thermal energy to be transferred from the cryostat to the thermal battery, thereby increasing the temperature of the thermal battery and decreasing the temperature of the cryostat. This can be considered as pre-cooling of the cryostat. After such pre-cooling, the cryostat can perform a cool-down cycle, and such cool-down cycle can consume less time or less electrical energy than it otherwise would have consumed (e.g., since the cryostat can have been pre-cooled, the cool-down cycle of the cryostat can be responsible for traversing a smaller temperature range than it would have had to traverse in the absence of pre-cooling). Similarly, in cases where the thermal battery is initially warmer than the cryostat, circulating the working fluid can cause thermal energy to be transferred from the thermal battery to the cryostat, thereby decreasing the temperature of the thermal battery and increasing the temperature of the cryostat. This can be considered as pre-warming of the cryostat. After such pre-warming, the cryostat can perform a warm-up cycle, and such warm-up cycle can consume less time or less electrical energy than it otherwise would have consumed (e.g., since the cryostat can have been pre-warmed, the warm-up cycle of the cryostat can be responsible for traversing a smaller temperature range than it would have had to traverse in the absence of pre-warming).

As a non-limiting example, suppose that the thermal battery begins at room temperature and that the cryostat begins at cryogenic temperatures (e.g., the cryostat can have last completed a cool-down cycle instead of a warm-up cycle). In such case, the thermal battery can be used to perform pre-warming, which can increase the temperature of the cryostat, and which can decrease the temperature of the thermal battery to below room temperature. After such pre-warming, the cryostat can perform a warm-up cycle to get to room temperature. Again, such warm-up cycle can consume less time or less electrical energy than it otherwise would have consumed, thanks to the pre-warming. Now, at this point, the cryostat can be at room temperature, but the thermal battery can have remained below room temperature, since the thermal battery can be thermally isolated from the ambient environment. Accordingly, when it is desired for the cryostat to return back to cryogenic temperatures, the thermal battery can be used to perform pre-cooling, which can decrease the temperature of the cryostat to below room temperature, and which can increase the temperature of the thermal battery (though the thermal battery can still be below room temperature). After such pre-cooling, the cryostat can perform a cool-down cycle to get back to cryogenic temperatures. Again, such cool-down cycle can consume less time or less electrical energy than it otherwise would have consumed, thanks to the pre-cooling. Note that, at such point, the thermal battery can be considered as once again being at a higher temperature than the cryostat, and so pre-warming can once again be performed when desired. In this way, the thermal battery can be implemented to perform multiple iterations of pre-warming and pre-cooling on the cryostat, with each iteration reducing by some non-zero amount the total time or electrical energy needed to perform a subsequent cool-down or warm-up cycle.

Because various embodiments described herein can cause the cryostat to consume less time or less electrical energy during cool-down cycles or warm-up cycles as compared to existing techniques, such embodiments certainly constitute a concrete and tangible technical improvement in the field of cryogenic systems.

It should be appreciated that the figures and the herein disclosure describe non-limiting examples of various embodiments. It should further be appreciated that the figures are not necessarily drawn to scale.

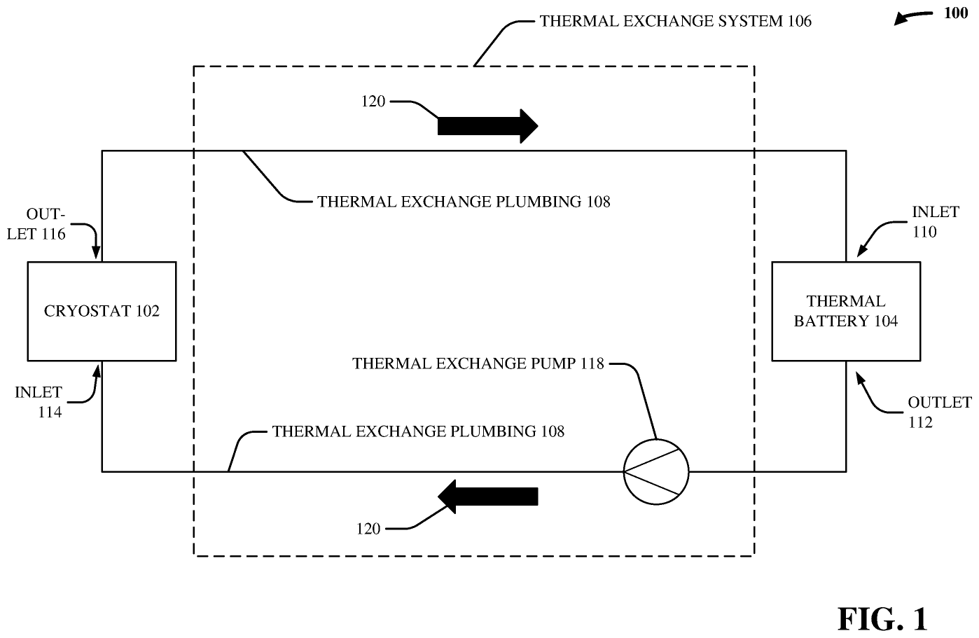

FIG. 1 illustrates a structural diagram of an example, non-limiting system 100 that can facilitate scalable thermal energy recycling for cryogenic systems in accordance with one or more embodiments described herein. As shown, the system 100 can comprise a cryostat 102, a thermal battery 104, or a thermal exchange system 106.

In various embodiments, the cryostat 102 can be any suitable type of cryostat. As a non-limiting example, the cryostat 102 can be a closed-cycle cryostat. As another non-limiting example, the cryostat 102 can be a continuous-flow cryostat. As even another non-limiting example, the cryostat 102 can be a multi-stage cryostat.

In various aspects, the cryostat 102 can contain or otherwise house any suitable number of any suitable types of quantum processors. As a non-limiting example, the cryostat 102 can contain or otherwise house any suitable quantum processors that implement quantum dot qubit architectures. As another non-limiting example, the cryostat 102 can contain or otherwise house any suitable quantum processors that implement spin qubit architectures. As yet another non-limiting example, the cryostat 102 can contain or otherwise house any suitable quantum processors that implement superconducting qubit architectures.

In various instances, the cryostat 102 can be configured to perform cool-down cycles or warm-up cycles. During a cool-down cycle, the cryostat 102 can decrease (e.g., via cryogenic compressors circulating a cryogen) its temperature to cryogenic levels (e.g., to tens of Kelvin, to below 5 Kelvin, to mere milli-Kelvin), for the purpose of operating the quantum processors housed in the cryostat 102. In contrast, during a warm-up cycle, the cryostat 102 can increase (e.g., via heating coils or via passive ambient heat transfer) its temperature to room temperature levels (e.g., to about 300 Kelvin), for the purpose of performing maintenance tasks (e.g., repairs, updates, replacements) on the quantum processors housed in the cryostat 102.

In various aspects, the thermal battery 104 can be any suitable tangible object having any suitable size, any suitable shape, or any suitable chemical composition, whose temperature can non-negligibly change (e.g., can increase or decrease by any suitable threshold margin) in response to receiving thermal energy from the cryostat 102 or in response to supplying thermal energy to the cryostat 102. As a non-limiting example, the thermal battery 104 can be a metallic object having any suitable dimensions, any suitable mass, and any suitable heat capacity.

In various instances, the thermal battery 104 can be thermally isolated, via any suitable thermal insulation techniques, from an ambient environment surrounding the cryostat 102, such that no or at most negligible (e.g., below any suitable threshold amount of) heat transfer can occur between the thermal battery 104 and the ambient environment. As a non-limiting example, the thermal battery 104 can be suspended within a vacuum chamber, such that the thermal battery 104 can be considered as being vacuum-insulated from the ambient environment. Such vacuum-insulation can be considered as increasing an amount of thermal resistance between the thermal battery 104 and the ambient environment. As another non-limiting example, the vacuum chamber in which the thermal battery 104 can be suspended can be outfitted, internally or externally, with any suitable thermal barriers, such as heat shields or layers of thermal insulation materials. Such thermal barriers can be considered as further increasing the amount of thermal resistance between the thermal battery 104 and the ambient environment. As still another non-limiting example, the vacuum chamber in which the thermal battery 104 can be suspended can be positioned, located, or otherwise installed underground. Such underground installation can be considered as even further increasing the amount of thermal resistance between the thermal battery 104 and the ambient environment. In various instances, any other suitable thermal insulation techniques can be implemented with respect to the thermal battery 104, so as to increase the amount of thermal resistance between the thermal battery 104 and the ambient environment, and thus such that no or at most negligible heat transfer can occur between the thermal battery 104 and the ambient environment.

In various aspects, the thermal battery 104 can be coupled to the cryostat 102 by the thermal exchange system 106. In various instances, the thermal exchange system 106 can comprise thermal exchange plumbing 108. In various cases, the thermal exchange plumbing 108 can be any suitable type of piping, tubing, or conduit through which any suitable thermal exchange fluid (e.g., ³He, ⁴He) can flow. In various aspects, the thermal exchange plumbing 108 can be thermally isolated from the ambient environment, such that no or at most negligible (e.g., below any suitable threshold amount of) heat transfer can occur between the ambient environment and the thermal exchange fluid that can flow through the thermal exchange plumbing 108. As a non-limiting example, the thermal exchange plumbing 108 can be or otherwise comprise vacuum-insulated piping, which can increase an amount of thermal resistance between the thermal exchange fluid and the ambient environment. As another non-limiting example, the thermal exchange plumbing 108 can comprise or otherwise be outfitted with any suitable thermal barriers, such as heat shields or thermal insulation materials, which can further increase the amount of thermal resistance between the thermal exchange fluid and the ambient environment. As even another non-limiting example, the thermal exchange plumbing 108 can be positioned, located, or otherwise installed underground, which can yet further increase the amount of thermal resistance between the thermal exchange fluid and the ambient environment. In various instances, any other suitable thermal insulation techniques can be implemented with respect to the thermal exchange plumbing 108, so as to increase the amount of thermal resistance between the thermal exchange fluid and the ambient environment, and thus such that no or at most negligible heat transfer can occur between the thermal exchange fluid and the ambient environment.

In any case, the thermal exchange plumbing 108 can form a closed loop between the cryostat 102 and the thermal battery 104. Indeed, in various aspects, the thermal exchange plumbing 108 can run or otherwise be fed through an interior of the thermal battery 104 and also through an interior of the cryostat 102. More specifically, as shown, the thermal exchange plumbing 108 can run or otherwise be fed: from an inlet 110 of the thermal battery 104 to an outlet 112 of the thermal battery 104; from the outlet 112 of the thermal battery 104 to an inlet 114 of the cryostat 102, from the inlet 114 of the cryostat 102 to an outlet 116 of the cryostat 102; and from the outlet 116 of the cryostat 102 to the inlet 110 of the thermal battery 104.

In various aspects, the thermal exchange system 106 can further comprise a thermal exchange pump 118. Although FIG. 1 depicts the thermal exchange system 106 as having a single thermal exchange pump (e.g., one instance of 118), this is a mere non-limiting example for ease of illustration. In various cases, the thermal exchange system 106 can comprise any suitable number of thermal exchange pumps.

In various instances, the thermal exchange pump 118 can be any suitable device that can circulate or otherwise propel the thermal exchange fluid through the closed loop formed by the thermal exchange plumbing 108. In the non-limiting example shown in FIG. 1, a direction in which the thermal exchange fluid can be circulated or propelled by the thermal exchange pump 118 can be denoted by numeral 120. Accordingly, the thermal exchange pump 118 can thus cause the thermal exchange fluid to be circulated from the inlet 110 of the thermal battery 104 to the outlet 112 of the thermal battery 104, to the inlet 114 of the cryostat 102, to the outlet 116 of the cryostat 102, and back to the inlet 110 of the thermal battery 104.

In various aspects, there can be a temperature differential between the thermal battery 104 and the cryostat 102. In other words, the temperature of the thermal battery 104 can initially be different from the temperature of the cryostat 102. In the presence of such temperature differential, circulation or propulsion of the thermal exchange fluid through the thermal exchange plumbing 108 can cause non-negligible heat transfer to occur between the cryostat 102 and the thermal battery 104.

As a non-limiting example, suppose that the thermal battery 104 is initially at a higher temperature than the cryostat 102. In such case, the thermal exchange pump 118 can circulate or propel the thermal exchange fluid through the thermal exchange plumbing 108 in the direction denoted by numeral 120. Such circulation or propulsion can, in various instances, cause the thermal exchange fluid to be at a lower temperature than the thermal battery 104 as the thermal exchange fluid passes through the thermal battery 104. Thus, as the thermal exchange fluid flows through the thermal battery 104, the thermal exchange fluid can absorb thermal energy (e.g., heat) from the thermal battery 104, thereby decreasing the temperature of the thermal battery 104 and increasing the temperature of the thermal exchange fluid. Moreover, such circulation or propulsion can, in various cases, cause the thermal exchange fluid to be at a higher temperature than the cryostat 102 as the thermal exchange fluid passes through the cryostat 102. So, as the thermal exchange fluid flows through the cryostat 102, the thermal exchange fluid can reject thermal energy (e.g., heat) to the cryostat 102, thereby increasing the temperature of the cryostat 102 and decreasing the temperature of the thermal exchange fluid. In this way, the thermal exchange system 106 can be considered as transferring thermal energy from the thermal battery 104 to the cryostat 102. In various cases, this can be referred to as pre-warming of the cryostat 102.

As another non-limiting example, suppose that the thermal battery 104 is initially at a lower temperature than the cryostat 102. In such case, the thermal exchange pump 118 can circulate or propel the thermal exchange fluid through the thermal exchange plumbing 108 in the direction denoted by numeral 120. Such circulation or propulsion can, in various instances, cause the thermal exchange fluid to be at a lower temperature than the cryostat 102 as the thermal exchange fluid passes through the cryostat 102. Thus, as the thermal exchange fluid flows through the cryostat 102, the thermal exchange fluid can absorb thermal energy (e.g., heat) from the cryostat 102, thereby decreasing the temperature of the cryostat 102 and increasing the temperature of the thermal exchange fluid. Furthermore, such circulation or propulsion can, in various cases, cause the thermal exchange fluid to be at a higher temperature than the thermal battery 104 as the thermal exchange fluid passes through the thermal battery 104. So, as the thermal exchange fluid flows through the thermal battery 104, the thermal exchange fluid can reject thermal energy (e.g., heat) to the thermal battery 104, thereby increasing the temperature of the thermal battery 104 and decreasing the temperature of the thermal exchange fluid. In this way, the thermal exchange system 106 can be considered as transferring thermal energy from the cryostat 102 to the thermal battery 104. In various cases, this can be referred to as pre-cooling of the cryostat 102.

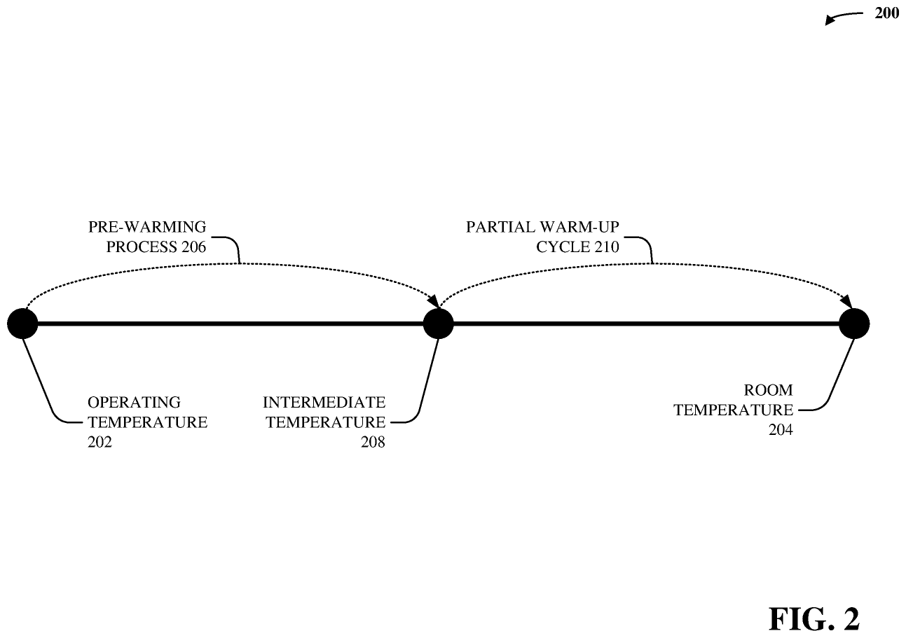

In various aspects, pre-warming of the cryostat 102 can be facilitated prior to the performance of a warm-up cycle of the cryostat 102, and such pre-warming can cause such warm-up cycle to consume less time or less electrical energy than it otherwise would have consumed. This is further explained with respect to FIG. 2.

FIG. 2 illustrates an example, non-limiting block diagram 200 showing how pre-warming via the thermal battery 104 can affect the temperature of the cryostat 102 in accordance with one or more embodiments described herein.

In various aspects, in order for the quantum processors housed by or otherwise contained within the cryostat 102 to operate properly, the cryostat 102 can have to be at an operating temperature 202. As a non-limiting example, the operating temperature 202 can be less than or equal to 5 Kelvin (e.g., can be on the order of milli-Kelvin). Conversely, in order for maintenance tasks to be performed on the quantum processors housed by or otherwise within the cryostat 102, the cryostat 102 can have to be at a room temperature 204. As a non-limiting example, the room temperature 204 can be about 300 Kelvin.

In various aspects, suppose that the cryostat 102 is currently at the operating temperature 202, further suppose that it is desired to get the cryostat 102 to the room temperature 204, and yet further suppose that the temperature of the thermal battery 104 is currently higher than the operating temperature 202. In such case, the thermal battery 104 and the thermal exchange system 106 can be implemented to perform a pre-warming process 206 on the cryostat 102. In various instances, the pre-warming process 206 can involve the thermal exchange pump 118 circulating or otherwise propelling the thermal exchange fluid through the thermal exchange plumbing 108. Because the temperature of the thermal battery 104 can be currently higher than the temperature of the cryostat 102, such circulation or propulsion can cause the thermal exchange fluid to absorb thermal energy from the thermal battery 104 and to deposit thermal energy to the cryostat 102. Thus, the pre-warming process 206 can cause the temperature of the thermal battery 104 to fall and the temperature of the cryostat 102 to rise. In various aspects, the pre-warming process 206 can, at some point in time, cause the temperature of the thermal battery 104 to become equal to, or to otherwise be within any suitable threshold margin of, the temperature of the cryostat 102. At such point in time, there can no longer be a temperature differential between the thermal battery 104 and the cryostat 102, and the thermal exchange fluid can thus be considered as no longer being able to transfer heat from the thermal battery 104 to the cryostat 102. In other words, the pre-warming process 206 can be considered as being completed at such point in time.

In various aspects, when the pre-warming process 206 is completed, the temperature of the cryostat 102 can be considered as being at an intermediate temperature 208, where the intermediate temperature 208 can be any suitable temperature that is greater than the operating temperature 202 and less than the room temperature 204. In various instances, because completion of the pre-warming process 206 can cause there to no longer be a temperature differential between the thermal battery 104 and the cryostat 102, the temperature of the thermal battery 104 can likewise be considered as being at the intermediate temperature 208. In various cases, the intermediate temperature 208 can be approximated as follows:

$${T}_{pre - warmed} = \frac{{m}_{cryostat} {c}_{cryostat} {T}_{cryostat}^{initial} + {m}_{battery} {c}_{battery} {T}_{battery}^{initial}}{{m}_{cryostat} {c}_{cryostat} + {m}_{battery} {c}_{battery}}$$

where T_{pre-warmed} can represent the intermediate temperature 208 (e.g., the temperature of the cryostat 102 and of the thermal battery 104 after the pre-warming process 206 is performed); where T_{cryostat}^{initial} can represent the temperature of the cryostat 102 before the pre-warming process 206 is performed (e.g., in this non-limiting example, T_{cryostat}^{initial} can be the operating temperature 202); where T_{battery}^{initial} battery can represent the temperature of the thermal battery 104 before the pre-warming process 206 is performed (e.g., T_{battery}^{initial} can be greater than T_{cryostat}^{initial}); where m_{cryostat} can be the total mass of the cryostat 102 (e.g., including the masses of the quantum processors housed within the cryostat 102); where m_{battery} can be the total mass of the thermal battery 104; where c_{cryostat} can be the total or equivalent heat capacity of the cryostat 102 (e.g., including the heat capacities of the quantum processors housed within the cryostat 102); and where c_{battery} can be the heat capacity of the thermal battery 104. Note that this formula is a mere approximation made using various simplifying assumptions (e.g., assuming that the system 100 has perfect coupling, constant heat capacities, and no phase changes). Accordingly, more accurate, yet more complicated, formulations for approximating the intermediate temperature 208 can be derived by using fewer simplifying assumptions (e.g., by assuming imperfect coupling between the thermal battery 104, the thermal exchange system 106, and the cryostat 102; by assuming temperature-dependent heat capacities; by assuming phase changes in the thermal exchange fluid).

In various aspects, after completion of the pre-warming process 206, the cryostat 102 can perform a partial warm-up cycle 210. In various instances, the partial warm-up cycle 210 can be active, in which case various heating coils of the cryostat 102 can be activated. In various other instances, the partial warm-up cycle 210 can be passive, in which case the cryostat 102 can be slowly warmed by heat transfer with the ambient environment. In either case, the partial warm-up cycle 210 can bring the temperature of the cryostat 102 from the intermediate temperature 208 to the room temperature 204. Contrast this with a full warm-up cycle that would instead (e.g., in the absence of the thermal battery 104, without the pre-warming process 206) have taken the cryostat 102 from the operating temperature 202 to the room temperature 204. In other words, the partial warm-up cycle 210 can be referred to as “partial” because it can traverse a smaller temperature range than a full warm-up cycle would have traversed (e.g., the difference between the room temperature 204 and the intermediate temperature 208 can be smaller than the difference between the room temperature 204 and the operating temperature 202).

In various aspects, the pre-warming process 206 can cause the cryostat 102 to consume less time or less electrical energy during warm-up. More specifically, the pre-warming process 206 can consume some non-zero amount of time and electrical energy. In particular, the thermal exchange pump 118 can circulate or propel the thermal exchange fluid in response to inputted electrical energy, and it can take some amount of time for the circulation or propulsion of the thermal exchange fluid to bring the cryostat 102 from the operating temperature 202 to the intermediate temperature 208. However, the amount of electrical energy consumed during the pre-warming process 206 can be lower (e.g., in some cases, orders of magnitude lower) than the amount of electrical energy that would have been consumed if the cryostat 102 instead utilized active warm-up to bring the cryostat 102 from the operating temperature 202 to the intermediate temperature 208 (e.g., the thermal exchange pump 118 can be less energy expensive than the heating coils of the cryostat 102). In other words, if the partial warm-up cycle 210 is active, then the total amount of electrical energy consumed by the pre-warming process 206 and by the partial warm-up cycle 210 can be less than the total amount of electrical energy that would have instead been consumed by a full warm-up cycle. That is, the electrical energy saved by the cryostat 102 by performing the partial warm-up cycle 210 instead of a full active warm-up cycle can be greater than the electrical energy consumed by the thermal exchange pump 118 during the pre-warming process 206.

Similarly, the amount of time consumed during the pre-warming process 206 can be lower (e.g., in some cases, orders of magnitude lower) than the amount of time that would have been consumed if the cryostat 102 instead utilized passive warm-up to bring the cryostat 102 from the operating temperature 202 to the intermediate temperature 208 (e.g., the thermal exchange pump 118 can heat the cryostat 102 more rapidly than can ambient environmental heat transfer). In other words, if the partial warm-up cycle 210 is passive, then the total amount of time consumed by the pre-warming process 206 and by the partial warm-up cycle 210 can be less than the total amount of time that would have instead been consumed by a full warm-up cycle. That is, the time saved by the cryostat 102 by performing the partial warm-up cycle 210 instead of a full passive warm-up cycle can be greater than the time consumed by the thermal exchange pump 118 during the pre-warming process 206.

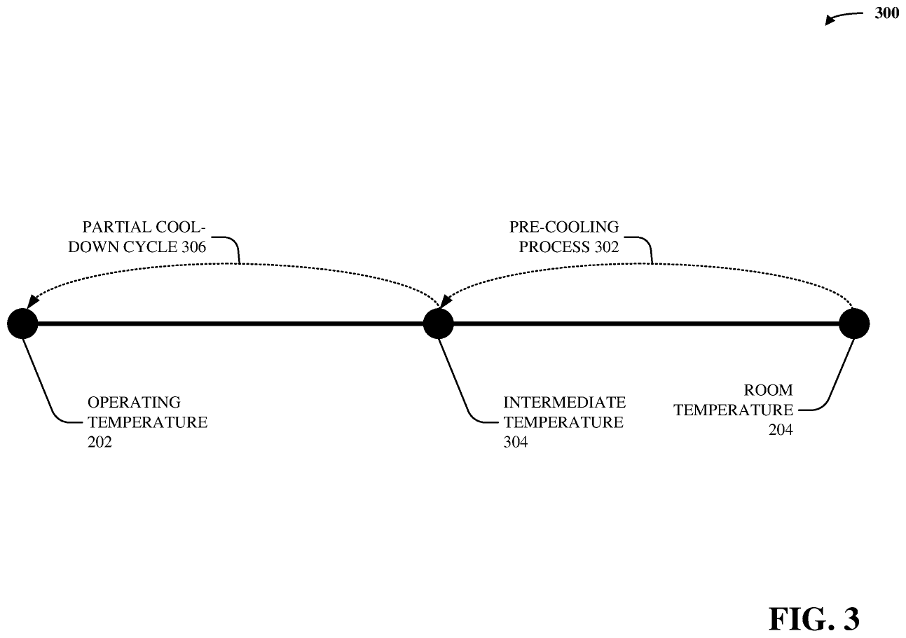

In various aspects, pre-cooling of the cryostat 102 can be facilitated prior to the performance of a cool-down cycle of the cryostat 102, and such pre-cooling can cause such cool-down cycle to consume less time or less electrical energy than it otherwise would have consumed. This is further explained with respect to FIG. 3.

FIG. 3 illustrates an example, non-limiting block diagram 300 showing how pre-cooling via the thermal battery 104 can affect the temperature of the cryostat 102 in accordance with one or more embodiments described herein.

As mentioned above, the cryostat 102 can have to be at the operating temperature 202 in order for the quantum processors contained within the cryostat 102 to operate properly, and the cryostat 102 can instead have to be at the room temperature 204 in order for maintenance tasks to be performed on the quantum processors contained within the cryostat 102.

In various aspects, suppose that the cryostat 102 is currently at the room temperature 204, further suppose that it is desired to get the cryostat 102 to the operating temperature 202, and yet further suppose that the temperature of the thermal battery 104 is currently lower than the room temperature 204. In such case, the thermal battery 104 and the thermal exchange system 106 can be implemented to perform a pre-cooling process 302 on the cryostat 102. In various instances, the pre-cooling process 302 can involve the thermal exchange pump 118 circulating or otherwise propelling the thermal exchange fluid through the thermal exchange plumbing 108. Because the temperature of the thermal battery 104 can be currently lower than the temperature of the cryostat 102, such circulation or propulsion can cause the thermal exchange fluid to absorb thermal energy from the cryostat 102 and to deposit thermal energy to the thermal battery 104. Thus, the pre-cooling process 302 can cause the temperature of the thermal battery 104 to rise and the temperature of the cryostat 102 to fall. In various aspects, the pre-cooling process 302 can, at some point in time, cause the temperature of the thermal battery 104 to become equal to, or to otherwise be within any suitable threshold margin of, the temperature of the cryostat 102. At such point in time, there can no longer be a temperature differential between the thermal battery 104 and the cryostat 102, and the thermal exchange fluid can thus be considered as no longer being able to transfer heat from the cryostat 102 to the thermal battery 104. In other words, the pre-cooling process 302 can be considered as being completed at such point in time.

In various aspects, when the pre-cooling process 302 is completed, the temperature of the cryostat 102 can be considered as being at an intermediate temperature 304, where the intermediate temperature 304 can be any suitable temperature that is greater than the operating temperature 202 and less than the room temperature 204. In various instances, because completion of the pre-cooling process 302 can cause there to no longer be a temperature differential between the thermal battery 104 and the cryostat 102, the temperature of the thermal battery 104 can likewise be considered as being at the intermediate temperature 304. In various cases, the intermediate temperature 304 can be approximated as follows:

$${T}_{pre - cooled} = \frac{{m}_{cryostat} {c}_{cryostat} {T}_{cryostat}^{initial} + {m}_{battery} {c}_{battery} {T}_{battery}^{initial}}{{m}_{cryostat} {c}_{cryostat} + {m}_{battery} {c}_{battery}}$$

where T_{pre-cooled} can represent the intermediate temperature 208 (e.g., the temperature of the cryostat 102 and of the thermal battery 104 after the pre-cooling process 302 is performed); where T_{cryostat}^{initial} can represent the temperature of the cryostat 102 before the pre-cooling process 302 is performed (e.g., in this non-limiting example, T_{cryostat}^{initial} can be the room temperature 204); where T_{battery}^{initial} can represent the temperature of the thermal battery 104 before the pre-cooling process 302 is performed (e.g., T_{battery}^{initial} can be less than T_{cryostat}^{initial}); where m_{cryostat} can be the total mass of the cryostat 102 (e.g., including the masses of the quantum processors housed within the cryostat 102); where m_{battery} can be the total mass of the thermal battery 104; where c_{cryostat} can be the total or equivalent heat capacity of the cryostat 102 (e.g., including the heat capacities of the quantum processors housed within the cryostat 102); and where c_{battery} can be the heat capacity of the thermal battery 104. As above, note that this formula is a mere approximation made using various simplifying assumptions (e.g., assuming that the system 100 has perfect coupling, constant heat capacities, and no phase changes). Accordingly, more accurate, yet more complicated, formulations for approximating the intermediate temperature 304 can be derived by using fewer simplifying assumptions (e.g., by assuming imperfect coupling between the thermal battery 104, the thermal exchange system 106, and the cryostat 102; by assuming temperature-dependent heat capacities; by assuming phase changes in the thermal exchange fluid).

In various aspects, after completion of the pre-cooling process 302, the cryostat 102 can perform a partial cool-down cycle 306. In various instances, the partial cool-down cycle 306 can involve activating various cryogenic compressors of the cryostat 102. In various cases, the partial cool-down cycle 306 can bring the temperature of the cryostat 102 from the intermediate temperature 304 to the operating temperature 202. Contrast this with a full cool-down cycle that would instead (e.g., in the absence of the thermal battery 104, without the pre-cooling process 302) have taken the cryostat 102 from the room temperature 204 to the operating temperature 202. In other words, the partial cool-down cycle 306 can be referred to as “partial” because it can traverse a smaller temperature range than a full cool-down cycle would have traversed (e.g., the difference between the operating temperature 202 and the intermediate temperature 304 can be smaller than the difference between the operating temperature 202 and the room temperature 304).

In various aspects, the pre-cooling process 302 can cause the cryostat 102 to consume less electrical energy during cool-down. More specifically, the pre-cooling process 302 can consume some non-zero amount of electrical energy. In particular, the thermal exchange pump 118 can circulate or propel the thermal exchange fluid in response to inputted electrical energy. However, the amount of electrical energy consumed during the pre-cooling process 302 can be lower (e.g., in some cases, orders of magnitude lower) than the amount of electrical energy that would have been consumed if the cryostat 102 instead utilized a cool-down cycle to bring the cryostat 102 from the room temperature 204 to the intermediate temperature 304 (e.g., indeed, the thermal exchange pump 118 can be less energy expensive than the cryogenic compressors of the cryostat 102). In other words, the total amount of electrical energy consumed by the pre-cooling process 302 and by the partial cool-down cycle 306 can be less than the total amount of electrical energy that would have instead been consumed by a full cool-down cycle. In still other words, the electrical energy saved by the cryostat 102 by performing the partial cool-down cycle 306 instead of a full cool-down cycle can be greater than the electrical energy consumed by the thermal exchange pump 118 during the pre-cooling process 302.

Accordingly, implementation of the thermal battery 104 and of the thermal exchange system 106 as described herein can enable the cryostat 102 to consume less time or less electrical energy during warm-up cycles and cool-down cycles.

To help further understand various of the energy-saving benefits of the thermal battery 104 and of the thermal exchange system 106, consider the following, non-limiting example.

Suppose that the cryostat 102 has just completed a cool-down cycle. Accordingly, the cryostat 102 can be at the operating temperature 202. Moreover, suppose that the thermal battery 104 is currently at the room temperature 204. In such case, the thermal battery 104 can be warmer than the cryostat 102, and so the thermal battery 104 can be used to perform pre-warming on the cryostat 102. Such pre-warming can increase the temperature of the cryostat 102 and can decrease the temperature of the thermal battery 104, until both the cryostat 102 and the thermal battery 104 are at a first intermediate temperature, where such first intermediate temperature is greater than the operating temperature 202 but less than the room temperature 204. At such point, the cryostat 102 can perform a partial warm-up cycle, such that the cryostat 102 can now be at the room temperature 204. As explained above, such partial warm-up cycle can be less expensive (e.g., in terms of time or electrical energy) than a full warm-up cycle would have been.

In various aspects, since the thermal battery 104 and the thermal exchange system 106 can be thermally isolated from the ambient environment, the thermal battery 104 can remain at (or can otherwise change at most negligibly from) the first intermediate temperature for any suitable amount of time (e.g., for days, weeks, or even months on end, in some cases). In other words, pre-warming can be considered as causing the thermal battery 104 to store some of the “coldness” that the cryostat 102 previously had when the cryostat 102 was at the operating temperature 202.

In any case, because the thermal battery 104 can be at the first intermediate temperature, and because the cryostat 102 can be at the room temperature 204, the thermal battery 104 can, at this point in time, be cooler than the cryostat 102. Accordingly, when desired, the thermal battery 104 can be used to perform pre-cooling on the cryostat 102. Such pre-cooling can decrease the temperature of the cryostat 102 and can increase the temperature of the thermal battery 104, until both the cryostat 102 and the thermal battery 104 are at a second intermediate temperature, where the second intermediate temperature can be greater than the first intermediate temperature but less than the room temperature 204. At such point, the cryostat 102 can perform a partial cool-down cycle, such that the cryostat 102 can again be at the operating temperature 202. As explained above, such partial cool-down cycle can be less expensive than a full cool-down cycle would have been.

As mentioned above, since the thermal battery 104 and the thermal exchange system 106 can be thermally isolated from the ambient environment, the thermal battery 104 can remain at (or can otherwise change at most negligibly from) the second intermediate temperature for any suitable amount of time. That is, pre-cooling can be considered as causing the thermal battery 104 to store some of the heat that the cryostat 102 previously had when the cryostat 102 was at the room temperature 204.

In any case, because the thermal battery 104 can be at the second intermediate temperature, and because the cryostat 102 can be at the operating temperature 202, the thermal battery 104 can once again be warmer than the cryostat 102. Accordingly, when desired, the thermal battery 104 can be used to perform pre-warming on the cryostat 102. Such pre-warming can increase the temperature of the cryostat 102 and can decrease the temperature of the thermal battery 104, until both the cryostat 102 and the thermal battery 104 are at a third intermediate temperature, where the third intermediate temperature can be greater than the operating temperature 202 but less than the second intermediate temperature. At such point, the cryostat 102 can again perform a partial warm-up cycle, such that the cryostat 102 can once more be at the room temperature 204. As above, such partial warm-up cycle can be less expensive than a full warm-up cycle would have been.

Such pre-warming and pre-cooling processes can be repeated in this fashion as desired.

In this way, the thermal battery 104 and the thermal exchange system 106 can be leveraged to perform multiple, sequential iterations of pre-warming and pre-cooling of the cryostat 102, with each of such iterations storing some “coldness” or some heat that was previously contained in the cryostat 102, and where such stored “coldness” or stored heat can reduce an amount of time or electrical energy consumed by the cryostat 102 during a subsequent warm-up or cool-down cycle. In other words, the thermal battery 104 and the thermal exchange system 106 can be considered as recycling or otherwise reclaiming some of the thermal work that the cryostat 102 performed in previous cool-down or warm-up cycles, where such recycled or reclaimed thermal work can be used to reduce or otherwise offset the costs of operating the cryostat 102 during subsequent warm-up or cool-down cycles.

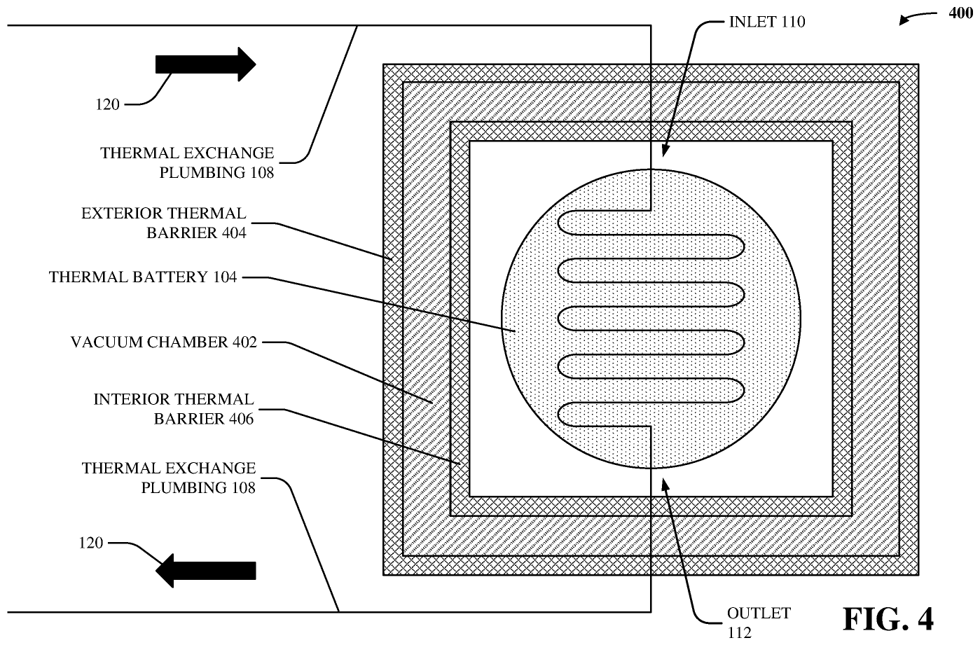

FIG. 4 illustrates a structural diagram 400 of an example, non-limiting embodiment of a thermal battery suspended in a vacuum chamber that can facilitate scalable thermal energy recycling for cryogenic systems in accordance with one or more embodiments described herein. In other words, FIG. 4 depicts an example, non-limiting embodiment of the thermal battery 104.

In various embodiments, as mentioned above, the thermal battery 104 can be any suitable tangible object capable of receiving or rejecting thermal energy. In some aspects, the thermal battery 104 can be a contiguous chunk of metal having any suitable mass or any suitable heat capacity. As a non-limiting example, the thermal battery 104 can be a 500-kilogram contiguous chunk of copper. In various other instances, however, the thermal battery 104 can be made up of any other suitable metals. Indeed, in some cases, the thermal battery 104 can be composed of any suitable combination of metals.

In various instances, the thermal battery 104 can have or otherwise exhibit any suitable size, any suitable shape, or any suitable dimensions. As a non-limiting example, the thermal battery 104 can be a sphere. After all, a sphere can be considered as the geometric shape that has a minimized surface-area-to-volume ratio. Accordingly, by shaping the thermal battery 104 as a sphere, an outgoing heat flux across the surface area of the thermal battery 104 can be reduced or otherwise minimized. Accordingly, such reduced or minimized outgoing heat flux can help to make the thermal battery 104 more thermally isolated from the ambient environment.

In various aspects, as shown, the thermal battery 104 can be suspended in a vacuum chamber 402. In various instances, the thermal battery 104 can be suspended within the vacuum chamber 402 via any suitable suspension techniques. As a non-limiting example, the thermal battery 104 can be hung or otherwise affixed like a chandelier in the vacuum chamber 402. In any case, the vacuum chamber 402 can be evacuated of air or other gases, so as to reduce or otherwise eliminate convective heat transfer from affecting the surface area of the thermal battery 104. Such reduced or eliminated convective heat transfer can further reduce the outgoing heat flux across the surface area of the thermal battery 104, thereby helping to make the thermal battery 104 more thermally isolated from the ambient environment.

Although FIG. 4 shows the vacuum chamber 402 as having or otherwise exhibiting a rectilinear shape, this is a mere non-limiting example for ease of illustration. In various cases, the vacuum chamber 402 can have or otherwise exhibit any suitable size, any suitable shape, or any suitable dimensions (e.g., any suitable thicknesses).

In various aspects, an exterior portion of the vacuum chamber 402 can be coated, lined, covered, or otherwise protected by an exterior thermal barrier 404. In various instances, the exterior thermal barrier 404 can include any suitable heat shield materials, which can help to reduce radiative heat transfer into or out of the vacuum chamber 402. As some non-limiting examples, such heat shield materials can include steel, aluminum, or copper. In various other instances, the exterior thermal barrier 404 can include any suitable thermal insulation materials, which can help to reduce conductive heat transfer into or out of the vacuum chamber 402. As some non-limiting examples, such thermal insulation materials can include fiberglass, polyurethane, multi-layered aluminized mylar, or glass wool. In some instances, the exterior thermal barrier 404 can include any suitable combination of heat shield materials or thermal insulation materials. In any case, the exterior thermal barrier 404 can help to further reduce the outgoing heat flux across the surface area of the thermal battery 104, thereby helping to make the thermal battery 104 more thermally isolated from the ambient environment.

Although FIG. 4 shows the exterior thermal barrier 404 as having or otherwise exhibiting a rectilinear shape, this is a mere non-limiting example for ease of illustration. In various cases, the exterior thermal barrier 404 can have or otherwise exhibit any suitable size, any suitable shape, or any suitable dimensions (e.g., any suitable thicknesses).

In various aspects, an interior portion of the vacuum chamber 402 can be coated, lined, covered, or otherwise protected by an interior thermal barrier 406. In various instances, the interior thermal barrier 406 can include any suitable heat shield materials (e.g., steel, aluminum, copper), which can help to reduce radiative heat transfer into or out of the vacuum chamber 402. In various other instances, the interior thermal barrier 406 can include any suitable thermal insulation materials (e.g., fiberglass, polyurethane, multi-layered aluminized mylar, glass wool), which can help to reduce conductive heat transfer into or out of the vacuum chamber 402. In some instances, the interior thermal barrier 406 can include any suitable combination of heat shield materials or thermal insulation materials. In any case, the interior thermal barrier 406 can help to further reduce the outgoing heat flux across the surface area of the thermal battery 104, thereby helping to make the thermal battery 104 more thermally isolated from the ambient environment.

Although FIG. 4 shows the interior thermal barrier 406 as having or otherwise exhibiting a rectilinear shape, this is a mere non-limiting example for ease of illustration. In various cases, the interior thermal barrier 406 can have or otherwise exhibit any suitable size, any suitable shape, or any suitable dimensions (e.g., any suitable thicknesses).

Although not explicitly shown in FIG. 4, the thermal battery 104 can be coated, lined, covered, wrapped, or otherwise protected by any other suitable thermal barrier (e.g., by any suitable combination of heat shield materials or thermal insulation materials), so as to help even further reduce the outgoing heat flux across the surface area of the thermal battery 104, thereby helping to make the thermal battery 104 more thermally isolated from the ambient environment.

In various aspects, after exiting the outlet 116 of the cryostat 102, the thermal exchange plumbing 108 can pass through the exterior thermal barrier 404, through a wall of the vacuum chamber 402, and through the interior thermal barrier 406, so as to reach the inlet 110 of the thermal battery 104. In various instances, as shown, the thermal exchange plumbing 108 can pass through the thermal battery 104, so as to connect the inlet 110 to the outlet 112. More specifically, the thermal exchange plumbing 108 can, in various cases and as shown, meander or wind (e.g., in any suitable fashion or layout) through an interior of the thermal battery 104. In various aspects, such meandering or winding can be considered as increasing an amount of surface area of the thermal exchange plumbing 108 that is in thermal contact with the thermal battery 104. In various instances, such increased surface area can help to increase a rate of heat transfer that can occur between the thermal battery 104 and the thermal exchange fluid that flows through the thermal exchange plumbing 108. In any case, as shown, the thermal exchange plumbing 108 can run from the outlet 112, again through the interior thermal barrier 406, again through a wall of the vacuum chamber 402, and again through the exterior thermal barrier 404, and the thermal exchange plumbing 108 can then lead to the inlet 114 of the cryostat 102.

In some cases, the thermal exchange plumbing 108 can be considered as coupling the thermal battery 104 to an exterior or outside of the vacuum chamber 402.

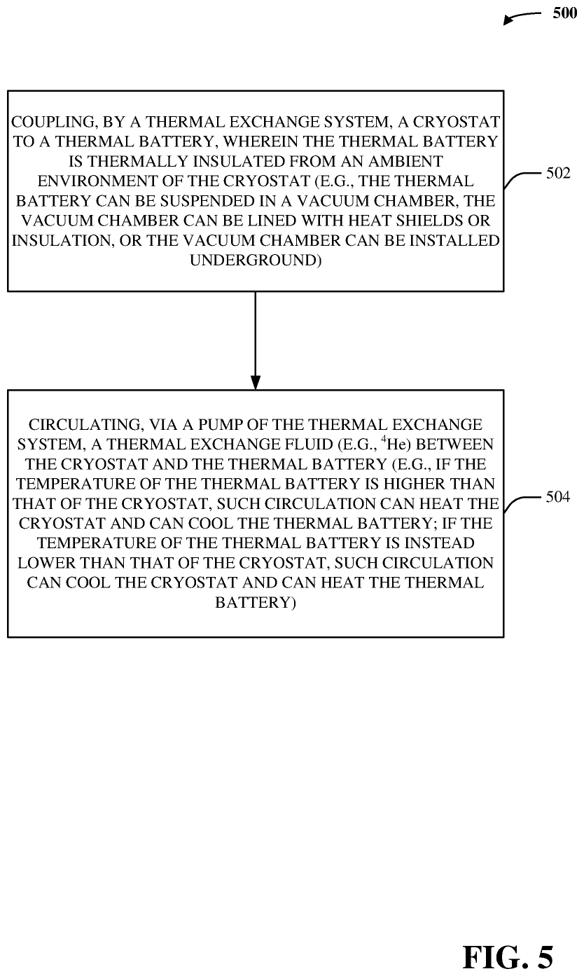

FIG. 5 illustrates a flow diagram of an example, non-limiting method 500 that can facilitate scalable thermal energy recycling for cryogenic systems in accordance with one or more embodiments described herein.

In various embodiments, act 502 can include coupling, by a thermal exchange system (e.g., 106), a cryostat (e.g., 102) to a thermal battery (e.g., 104). In various cases, the thermal battery can be thermally insulated (e.g., thermally isolated) from an ambient environment surrounding the cryostat. As a non-limiting, the thermal battery can be suspended in a vacuum chamber (e.g., 402). As another non-limiting example, the vacuum chamber can be lined with heat shields or insulation (e.g., 404, 406). As yet another non-limiting example, the vacuum chamber can be installed underground.

In various aspects, act 504 can include circulating, via a pump (e.g., 118) of the thermal exchange system, a thermal exchange fluid (e.g., ³He, ⁴He) between the cryostat and the thermal battery. In various instances, the temperature of the thermal battery can be higher than that of the cryostat. In such case, circulation of the thermal exchange fluid can heat or otherwise warm the cryostat and can cool or otherwise chill the thermal battery. In various other instances, the temperature of the thermal battery can instead be lower than that of the cryostat. In such case, circulation of the thermal exchange fluid can cool or chill the cryostat and can heat or warm the thermal battery.

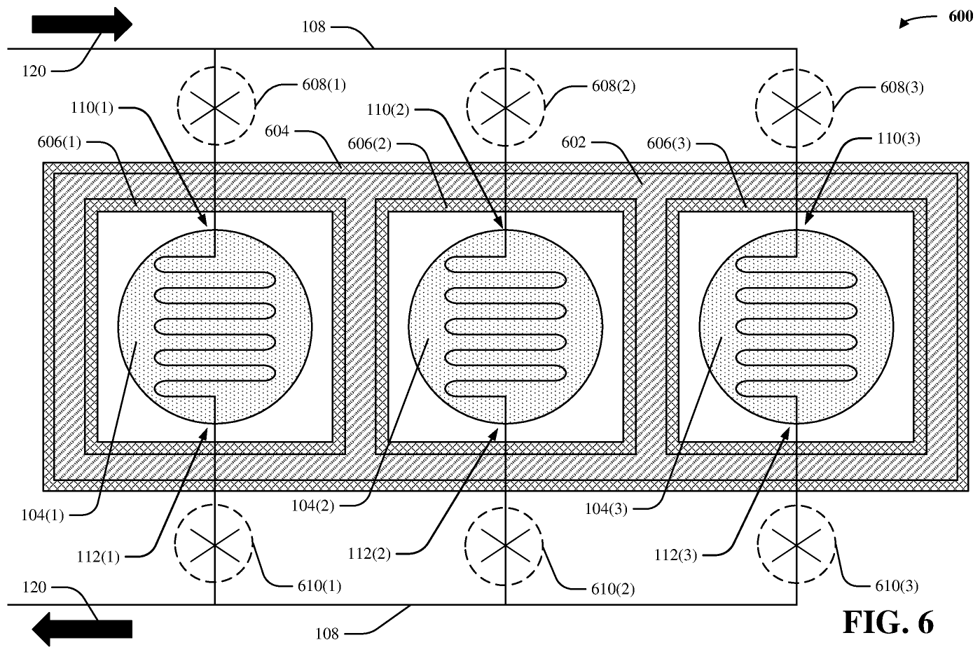

Thus far, the herein disclosure has mainly described the thermal battery 104 as exhibiting a single-cell architecture (e.g., as being a contiguous chunk of metal). This is a mere non-limiting example for ease of illustration and explanation. In various other embodiments, the thermal battery 104 can instead exhibit a multi-cell architecture (e.g., can instead be comprised of a plurality of separate, contiguous chunks of metal). Various non-limiting aspects pertaining to such other embodiments are described with respect to FIG. 6.

FIG. 6 illustrates a structural diagram 600 of an example, non-limiting embodiment of a multi-cell thermal battery that can facilitate scalable thermal energy recycling for cryogenic systems in accordance with one or more embodiments described herein. That is, FIG. 6 depicts a non-limiting example embodiment of the thermal battery 104, where the thermal battery 104 exhibits a multi-cell architecture.

In various embodiments, the thermal battery 104 can comprise a plurality of thermal cells. As shown, FIG. 6 depicts the thermal battery 104 as comprising three distinct thermal cells: a thermal cell 104(1), a thermal cell 104(2), and a thermal cell 104(3). However, this is a mere non-limiting example for ease of illustration. In various aspects, the plurality of thermal cells can include any other suitable number of thermal cells (e.g., can include two or more thermal cells).

In various aspects, a thermal cell of the thermal battery 104 can be any suitable tangible object capable of receiving or rejecting thermal energy. As a non-limiting example, the thermal cell 104(1) can be a first contiguous chunk of metal (e.g., copper) having any suitable mass, any suitable heat capacity, any suitable size, any suitable shape (e.g., spherical), or any suitable dimensions. As another non-limiting example, the thermal cell 104(2) can be a second contiguous chunk of metal having any suitable mass, any suitable heat capacity, any suitable size, any suitable shape, or any suitable dimensions. As yet another non-limiting example, the thermal cell 104(3) can be a third contiguous chunk of metal having any suitable mass, any suitable heat capacity, any suitable size, any suitable shape, or any suitable dimensions. In some cases, the plurality of thermal cells can have different masses than each other (e.g., the mass of the thermal cell 104(1) can be different from the mass of the thermal cell 104(2), which can be different from the mass of the thermal cell 104(3)). Likewise, in various aspects, the plurality of thermal cells can have different heat capacities than each other (e.g., the thermal cell 104(1) can composed of a different metal than the thermal cell 104(2), which can be composed of a different metal than the thermal cell 104(3)). Furthermore, in various instances, the plurality of thermal cells can have different shapes, sizes, or dimensions than each other (e.g., the thermal cell 104(1) can exhibit a different size, a different shape, or different dimensions than the thermal cell 104(2), which can exhibit a different size, a different shape, or different dimensions than the thermal cell 104(3)).

In various aspects, as shown, each of the plurality of thermal cells can be suspended in a vacuum chamber 602. As a non-limiting example, the thermal cell 104(1) can be suspended, hung, or otherwise affixed within a first room of the vacuum chamber 602, and that first room can be evacuated of air or other gases, so as to help make the thermal cell 104(1) more thermally isolated from the ambient environment. As another non-limiting example, the thermal cell 104(2) can be suspended, hung, or otherwise affixed within a second room of the vacuum chamber 602, and that second room can be evacuated of air or other gases, so as to help make the thermal cell 104(2) more thermally isolated from the ambient environment. As yet another non-limiting example, the thermal cell 104(3) can be suspended, hung, or otherwise affixed within a third room of the vacuum chamber 602, and that third room can be evacuated of air or other gases, so as to help make the thermal cell 104(3) more thermally isolated from the ambient environment.

Although FIG. 6 illustrates the thermal cell 104(1), the thermal cell 104(2), and the thermal cell 104(3) as each being within a distinct, respective room of the vacuum chamber 602, this is a mere non-limiting example. In various aspects, the thermal cell 104(1), the thermal cell 104(2), and the thermal cell 104(3) can all be suspended, hung, or otherwise affixed within a same room of the vacuum chamber 602.

Although FIG. 6 shows the vacuum chamber 602 as having or otherwise exhibiting a rectilinear shape, this is a mere non-limiting example for ease of illustration. In various cases, the vacuum chamber 602 can have or otherwise exhibit any suitable size, any suitable shape, or any suitable dimensions (e.g., any suitable thicknesses).

In various aspects, an exterior portion of the vacuum chamber 602 can be coated, lined, covered, or otherwise protected by an exterior thermal barrier 604. In various instances, the exterior thermal barrier 604 can be like the exterior thermal barrier 404 described above (e.g., can be any suitable combination of any suitable types of heat shielding materials or thermal insulation materials). Accordingly, the exterior thermal barrier 604 can help to make the thermal cell 104(1), the thermal cell 104(2), and the thermal cell 104(3) more thermally isolated from the ambient environment.

In various aspects, an interior portion of the vacuum chamber 602 can be coated, lined, covered, or otherwise protected by any suitable interior thermal barriers. For instance, the first room of the vacuum chamber 602 can be coated, lined, covered, or otherwise protected by an interior thermal barrier 606(1). In various cases, the interior thermal barrier 606(1) can be like the interior thermal barrier 406 described above (e.g., can be any suitable combination of any suitable types of heat shielding materials or thermal insulation materials). Accordingly, the interior thermal barrier 606(1) can help to make the thermal cell 104(1) more thermally isolated from the ambient environment. Similarly, the second room of the vacuum chamber 602 can be coated, lined, covered, or otherwise protected by an interior thermal barrier 606(2). In various cases, the interior thermal barrier 606(2) can be like the interior thermal barrier 406 described above (e.g., can be any suitable combination of any suitable types of heat shielding materials or thermal insulation materials). Thus, the interior thermal barrier 606(2) can help to make the thermal cell 104(2) more thermally isolated from the ambient environment. Likewise, the third room of the vacuum chamber 602 can be coated, lined, covered, or otherwise protected by an interior thermal barrier 606(3). In various cases, the interior thermal barrier 606(3) can be like the interior thermal barrier 406 described above (e.g., can be any suitable combination of any suitable types of heat shielding materials or thermal insulation materials). So, the interior thermal barrier 606(3) can help to make the thermal cell 104(3) more thermally isolated from the ambient environment.

Although not explicitly shown in FIG. 6, any of the plurality of thermal cells can be coated, lined, covered, wrapped, or otherwise protected by any other suitable thermal barriers (e.g., by any suitable combination of heat shield materials or thermal insulation materials), so as to help make the plurality of thermal cells even more thermally isolated from the ambient environment.

In various aspects, as shown, a first section of plumbing can branch off from the thermal exchange plumbing 108 at a location downstream of the cryostat 102 but upstream of the thermal battery 104. In various instances, that first section of plumbing can pass through the exterior thermal barrier 604, through a wall of the vacuum chamber 602, and through the interior thermal barrier 606(1), so as to reach an inlet 110(1) of the thermal cell 104(1). In various cases, as shown, that first section of plumbing can pass (e.g., in meandering or winding fashion) through the thermal cell 104(1), so as to connect the inlet 110(1) to an outlet 112(1) of the thermal cell 104(1). In various aspects, as shown, that first section of plumbing can run from the outlet 112(1), again through the interior thermal barrier 606(1), again through a wall of the vacuum chamber 602, and again through the exterior thermal barrier 604. That first section of plumbing can then re-merge with the thermal exchange plumbing 108 at a location that is downstream of the thermal battery 104 but upstream of the cryostat 102.

Similarly, a second section of plumbing can branch off from the thermal exchange plumbing 108 at a location downstream of the cryostat 102 but upstream of the thermal battery 104. In various aspects, that second section of plumbing can pass through the exterior thermal barrier 604, through a wall of the vacuum chamber 602, and through the interior thermal barrier 606(2), so as to reach an inlet 110(2) of the thermal cell 104(2). In various instances, as shown, that second section of plumbing can pass (e.g., in meandering or winding fashion) through the thermal cell 104(2), so as to connect the inlet 110(2) to an outlet 112(2) of the thermal cell 104(2). In various cases, as shown, that second section of plumbing can run from the outlet 112(2), again through the interior thermal barrier 606(2), again through a wall of the vacuum chamber 602, and again through the exterior thermal barrier 604. That second section of plumbing can then re-merge with the thermal exchange plumbing 108 at a location that is downstream of the thermal battery 104 but upstream of the cryostat 102.

Likewise, a third section of plumbing can branch off from the thermal exchange plumbing 108 at a location downstream of the cryostat 102 but upstream of the thermal battery 104. In various aspects, that third section of plumbing can pass through the exterior thermal barrier 604, through a wall of the vacuum chamber 602, and through the interior thermal barrier 606(3), so as to reach an inlet 110(3) of the thermal cell 104(3). In various instances, as shown, that third section of plumbing can pass (e.g., in meandering or winding fashion) through the thermal cell 104(3), so as to connect the inlet 110(3) to an outlet 112(3) of the thermal cell 104(3). In various cases, as shown, that third section of plumbing can run from the outlet 112(3), again through the interior thermal barrier 606(3), again through a wall of the vacuum chamber 602, and again through the exterior thermal barrier 604. That third section of plumbing can then re-merge with the thermal exchange plumbing 108 at a location that is downstream of the thermal battery 104 but upstream of the cryostat 102.

In other words, and as shown in FIG. 6, each of the plurality of thermal cells that make up the thermal battery 104 can be considered as being coupled together by the thermal exchange plumbing 108 in a parallel spatial arrangement, as opposed to being coupled together in a series spatial arrangement.

Furthermore, in various embodiments, the thermal exchange system 106 can comprise a plurality of actuatable valves, which can respectively correspond with the plurality of thermal cells. In various aspects, such plurality of actuatable valves can be configured to control whether or not the thermal exchange fluid can flow through respective ones of the plurality of thermal cells.

As a non-limiting example, the first section of plumbing that runs through the thermal cell 104(1) can comprise an actuatable valve 608(1) and an actuatable valve 610(1). In various instances, the actuatable valve 608(1) and the actuatable valve 610(1) can be any suitable electronically-controllable valves (e.g., ball valves, butterfly valves, gate valves) that can be toggled between open states and closed states. In various cases, as shown, the actuatable valve 608(1) can be positioned along the first section of plumbing at a location that is upstream of the inlet 110(1). In contrast, the actuatable valve 610(1) can be positioned along the first section of plumbing at a location that is downstream of the outlet 112(1). Accordingly, when both the actuatable valve 608(1) and the actuatable valve 610(1) are open, they can permit the thermal exchange fluid from the rest of the thermal exchange system 106 to flow through the thermal cell 104(1). In such case, the thermal cell 104(1) can be considered as being thermally integrated with the cryostat 102 (e.g., when both the actuatable valve 608(1) and the actuatable valve 610(1) are open, the thermal exchange fluid can facilitate non-negligible heat transfer between the thermal cell 104(1) and the cryostat 102). In contrast, when both the actuatable valve 608(1) and the actuatable valve 610(1) are closed, they can prevent the thermal exchange fluid from the rest of the thermal exchange system 106 from flowing through the thermal cell 104(1). In such case, the thermal cell 104(1) can be considered as being thermally isolated from the cryostat 102 (e.g., when both the actuatable valve 608(1) and the actuatable valve 610(1) are closed, the thermal exchange fluid cannot facilitate non-negligible heat transfer between the thermal cell 104(1) and the cryostat 102).

As another non-limiting example, the second section of plumbing that runs through the thermal cell 104(2) can comprise an actuatable valve 608(2) and an actuatable valve 610(2). As above, the actuatable valve 608(2) and the actuatable valve 610(2) can be any suitable electronically-controllable valves (e.g., ball valves, butterfly valves, gate valves) that can be toggled between open states and closed states. In various aspects, as shown, the actuatable valve 608(2) can be positioned along the second section of plumbing at a location that is upstream of the inlet 110(2). In contrast, the actuatable valve 610(2) can be positioned along the second section of plumbing at a location that is downstream of the outlet 112(2). Accordingly, when both the actuatable valve 608(2) and the actuatable valve 610(2) are open, they can permit the thermal exchange fluid from the rest of the thermal exchange system 106 to flow through the thermal cell 104(2). In such case, the thermal cell 104(2) can be considered as being thermally integrated with the cryostat 102 (e.g., when both the actuatable valve 608(2) and the actuatable valve 610(2) are open, the thermal exchange fluid can facilitate non-negligible heat transfer between the thermal cell 104(2) and the cryostat 102). In contrast, when both the actuatable valve 608(2) and the actuatable valve 610(2) are closed, they can prevent the thermal exchange fluid from the rest of the thermal exchange system 106 from flowing through the thermal cell 104(2). In such case, the thermal cell 104(2) can be considered as being thermally isolated from the cryostat 102 (e.g., when both the actuatable valve 608(2) and the actuatable valve 610(2) are closed, the thermal exchange fluid cannot facilitate non-negligible heat transfer between the thermal cell 104(2) and the cryostat 102).

As yet another non-limiting example, the third section of plumbing that runs through the thermal cell 104(3) can comprise an actuatable valve 608(3) and an actuatable valve 610(3). Just as above, the actuatable valve 608(3) and the actuatable valve 610(3) can be any suitable electronically-controllable valves (e.g., ball valves, butterfly valves, gate valves) that can be toggled between open states and closed states. In various aspects, as shown, the actuatable valve 608(3) can be positioned along the third section of plumbing at a location that is upstream of the inlet 110(3). In contrast, the actuatable valve 610(3) can be positioned along the third section of plumbing at a location that is downstream of the outlet 112(3). Accordingly, when both the actuatable valve 608(3) and the actuatable valve 610(3) are open, they can permit the thermal exchange fluid from the rest of the thermal exchange system 106 to flow through the thermal cell 104(3). In such case, the thermal cell 104(3) can be considered as being thermally integrated with the cryostat 102 (e.g., when both the actuatable valve 608(3) and the actuatable valve 610(3) are open, the thermal exchange fluid can facilitate non-negligible heat transfer between the thermal cell 104(3) and the cryostat 102). In contrast, when both the actuatable valve 608(3) and the actuatable valve 610(3) are closed, they can prevent the thermal exchange fluid from the rest of the thermal exchange system 106 from flowing through the thermal cell 104(3). In such case, the thermal cell 104(3) can be considered as being thermally isolated from the cryostat 102 (e.g., when both the actuatable valve 608(3) and the actuatable valve 610(3) are closed, the thermal exchange fluid cannot facilitate non-negligible heat transfer between the thermal cell 104(3) and the cryostat 102).

In various aspects, the plurality of actuatable valves can operate alternately with respect to each other, such that at most one of the plurality of the thermal cells is thermally integrated with the cryostat 102 at any given time, and such that the remainder of the plurality of thermal cells are thermally isolated from the cryostat 102 at that given time. As a non-limiting example, when the actuatable valve 608(1) and the actuatable valve 610(1) are open, the remaining actuatable valves (e.g., 608(2), 610(2), 608(3), 610(3)) can be closed. In such case, the thermal cell 104(1) can be thermally integrated with the cryostat 102, and the remainder of the plurality of thermal cells (e.g., 104(2), 104(3)) can be thermally isolated from the cryostat 102. As another non-limiting example, when the actuatable valve 608(2) and the actuatable valve 610(2) are open, the remaining actuatable valves (e.g., 608(1), 610(1), 608(3), 610(3)) can be closed. In such case, the thermal cell 104(2) can be thermally integrated with the cryostat 102, and the remainder of the plurality of thermal cells (e.g., 104(1), 104(3)) can be thermally isolated from the cryostat 102. As still another non-limiting example, when the actuatable valve 608(3) and the actuatable valve 610(3) are open, the remaining actuatable valves (e.g., 608(1), 610(1), 608(2), 610(2)) can be closed. In such case, the thermal cell 104(3) can be thermally integrated with the cryostat 102, and the remainder of the plurality of thermal cells (e.g., 104(1), 104(2)) can be thermally isolated from the cryostat 102.

In various aspects, the thermal exchange pump 118 can circulate or propel the thermal exchange fluid between the cryostat 102 and whichever particular thermal cell is currently thermally integrated with the cryostat 102. At some point in time, the temperature of the cryostat 102 can become equal to (or can otherwise come within any suitable threshold margin of) the temperature of that particular thermal cell. At such point in time, the actuatable valves corresponding to that particular thermal cell can be closed, so that such particular thermal cell can now be thermally isolated from the cryostat 102. Moreover, at such point in time, the actuatable valves corresponding to some other thermal cell can be opened, so that such other thermal cell can now be thermally integrated with the cryostat 102. Accordingly, the thermal exchange pump 118 can circulate or propel the thermal exchange fluid between the cryostat 102 and that other thermal cell. By implementing multiple thermal cells in this way, the plurality of thermal cells can be used sequentially to pre-warm or pre-cool the cryostat 102, thereby yielding a collectively greater magnitude of pre-warming or pre-cooling.

Indeed, in some cases, the masses, heat capacities, or initial temperatures of the plurality of thermal cells can be varied (e.g., can be different from each other), so that magnitudes of pre-warming or pre-cooling can be customized or tuned as desired.

As mentioned above, the plurality of actuatable valves (e.g., 608(1), 608(2), 608(3), 610(1), 610(2), 610(3)) can be electronically remote-controllable. In other words, the plurality of actuatable valves can be considered as comprising or otherwise being implemented with any suitable number of any suitable types of electronic controllers (e.g., any suitable computer processors, any suitable microprocessors, any suitable microcontrollers). More specifically, the plurality of actuatable valves can be toggled between open states and closed states (e.g., can be actuated) by such electronic controllers. For example, such electronic controllers can transmit “open” signals to individual ones of the plurality of actuatable valves, thereby causing those individual ones of the plurality of actuatable valves to open. As another example, such electronic controllers can transmit “close” signals to other individual ones of the plurality of actuatable valves, thereby causing those other individual ones of the plurality of actuatable valves to close. In some cases, each of the plurality of actuatable valves can be considered as comprising or otherwise being implemented with its own, distinct electronic controller. In other cases, two or more of the plurality of actuatable valves can be considered as comprising or otherwise being implemented with a shared electronic controller.

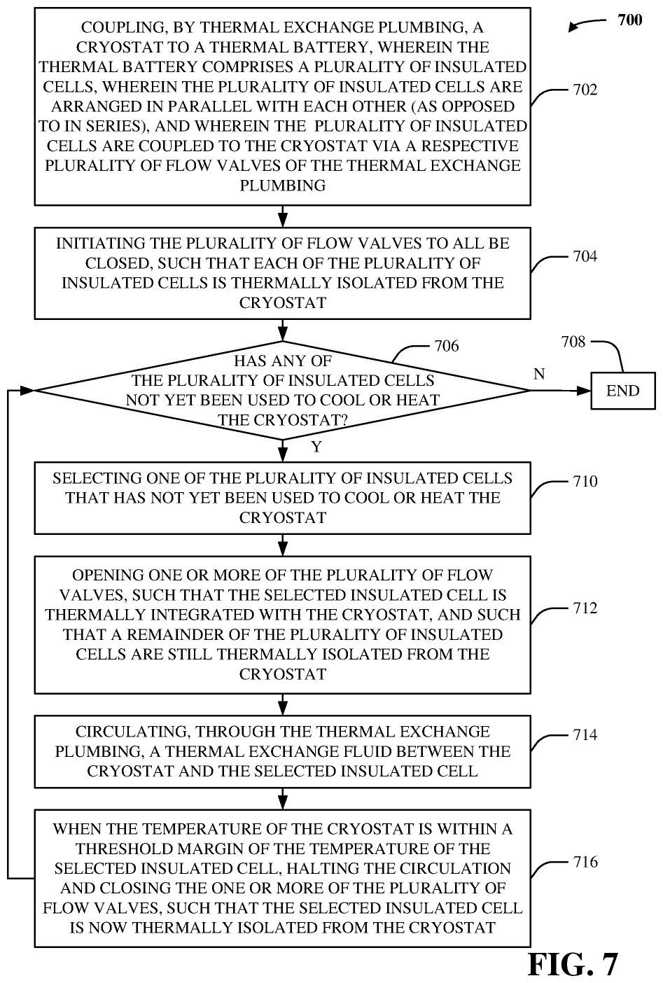

FIG. 7 illustrates a flow diagram of an example, non-limiting method 700 involving a multi-cell thermal battery that can facilitate scalable thermal energy recycling for cryogenic systems in accordance with one or more embodiments described herein.

In various embodiments, act 702 can include coupling, by thermal exchange plumbing (e.g., 108), a cryostat (e.g., 102) to a thermal battery (e.g., 104). In various aspects, the thermal battery can comprise a plurality of insulated cells (e.g., 104(1), 104(2), 104(3)) that can be arranged in parallel with each other, as opposed to in series with each other. In various instances, the plurality of insulated cells can be coupled to the cryostat via a respective plurality of flow valves (e.g., 608(1), 608(2), 608(3), 610(1), 610(2), 610(3)) of the thermal exchange plumbing.

In various cases, act 704 can include initiating the plurality of flow valves to all be closed. In various aspects, this can cause each of the plurality of insulated cells to be thermally isolated from the cryostat.

In various instances, act 706 can include determining whether any of the plurality of insulated cells has not yet been used to cool (or heat, as the case may be) the cryostat. If not (e.g., if all of the plurality of insulated cells have already been used to cool (or heat) the cryostat), then the method 700 can end at act 708. If so (e.g., if at least one of the plurality of insulated cells has not yet been used to cool (or heat) the cryostat), then the method 700 can proceed to act 710.

In various aspects, act 710 can include selecting one (e.g., 104(2)) of the plurality of insulated cells that has not yet been used to cool (or heat, as the case may be) the cryostat.

In various instances, act 712 can include opening one or more (e.g., 608(2), 610(2)) of the plurality of flow valves, such that the selected insulated cell is thermally integrated with the cryostat, and such that a remainder (e.g., 104(1), 104(3)) of the plurality of insulated cells are still thermally isolated from the cryostat.

In various cases, act 714 can include circulating, through the thermal exchange plumbing, a thermal exchange fluid (e.g., ³He, ⁴He) between the cryostat and the selected insulated cell. Such circulation can cause the thermal exchange fluid to facilitate heat transfer between the cryostat and the selected insulated cell (e.g., if the selected insulated cell is warmer than the cryostat, then such circulation can cool the selected insulated cell and can heat the cryostat; if the selected insulated cell is instead cooler than the cryostat, then such circulation can heat the selected insulated cell and can cool the cryostat).

In various aspects, act 716 can include halting the circulation of the thermal exchange fluid and closing the one or more of the plurality of flow valves, when the temperature of the cryostat is within a threshold margin of the temperature of the insulated cell (e.g., as determined via any suitable thermometers or thermocouples). In various instances, this can cause the selected insulated cell to now be thermally isolated from the cryostat. In various cases, the method 700 can proceed back to act 706.

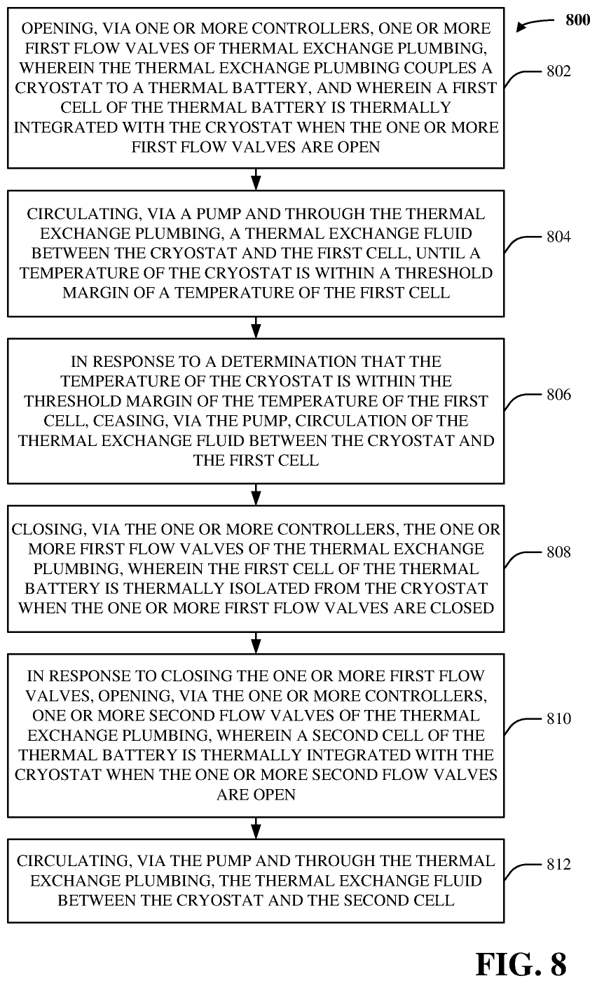

FIG. 8 illustrates a flow diagram of an example, non-limiting method 800 that can facilitate scalable thermal energy recycling for cryogenic systems in accordance with one or more embodiments described herein.

In various embodiments, act 802 can include opening, via one or more controllers (e.g., via any suitable computer processors), one or more first flow valves (e.g., 608(1), 610(1)) of thermal exchange plumbing (e.g., 108), wherein the thermal exchange plumbing can couple a cryostat (e.g., 102) to a thermal battery (e.g., 104). In various cases, a first cell (e.g., 104(1)) of the thermal battery can be thermally integrated with the cryostat when the one or more first flow valves are open.

In various aspects, act 804 can include circulating, via a pump (e.g., 118) and through the thermal exchange plumbing (e.g., 108), a thermal exchange fluid (e.g., ³He, ⁴He) between the cryostat (e.g., 102) and the first cell (e.g., 104(1)), until a temperature of the cryostat (e.g., 102) is within a threshold margin of a temperature of the first cell (e.g., 104(1)).

In various instances, act 806 can include, in response to a determination that the temperature of the cryostat (e.g., 102) is within the threshold margin of the temperature of the first cell (e.g., 104(1)), ceasing, via the pump (e.g., 118), circulation of the thermal exchange fluid between the cryostat (e.g., 102) and the first cell (e.g., 104(1)). In some cases, such determination can be based on temperature measurements captured by any suitable thermometers, thermocouples, or temperature sensors.

In various aspects, act 808 can include closing, via the one or more controllers, the one or more first flow valves (e.g., 608(1), 610(1)) of the thermal exchange plumbing. In various instances, the first cell (e.g., 104(1)) of the thermal battery can be thermally isolated from the cryostat (e.g., 102) when the one or more first flow valves (e.g., 608(1), 610(1)) are closed.

In various cases, act 810 can include, in response to closing the one or more first flow valves (e.g., 608(1), 610(1)), opening, via the one or more controllers, one or more second flow valves (e.g., 608(2), 610(2)) of the thermal exchange plumbing, wherein a second cell (e.g., 104(2)) of the thermal battery can be thermally integrated with the cryostat (e.g., 102) when the one or more second flow valves (e.g., 608(2), 610(2)) are open.

In various aspects, act 812 can include circulating, via the pump (e.g., 118) and through the thermal exchange plumbing (e.g., 108), the thermal exchange fluid between the cryostat (e.g., 102) and the second cell (e.g., 104(2)).

Although not explicitly shown in FIG. 8, the first cell (e.g., 104(1)) and the second cell (e.g., 104(2)) can have different masses or different heat capacities.

Although not explicitly shown in FIG. 8, the temperature of the cryostat (e.g., 102) can be below the temperature of the first cell (e.g., 104(1)), such that circulation of the thermal exchange fluid between the cryostat (e.g., 102) and the first cell (e.g., 104(1)) can cause the cryostat (e.g., 102) to be heated and the first cell (e.g., 104(1)) to be cooled.

Although not explicitly shown in FIG. 8, the temperature of the cryostat (e.g., 102) can be above the temperature of the first cell (e.g., 104(1)), such that circulation of the thermal exchange fluid between the cryostat (e.g., 102) and the first cell (e.g., 104(1)) can cause the cryostat (e.g., 102) to be cooled and the first cell (e.g., 104(1)) to be heated.

Various other embodiments described herein can include a device which can comprise: a thermal battery (e.g., 104) suspended in a vacuum chamber (e.g., 402 or 602); and thermal exchange plumbing (e.g., 108) that can couple the thermal battery to an exterior of the vacuum chamber. In various aspects, the thermal battery can comprise a spherical mass of copper. In various instances, the thermal battery can comprise at least two cells (e.g., 104(1), 104(2), 104(3)), and the at least two cells can have different masses or different heat capacities than each other. In various cases, the thermal exchange plumbing can comprise vacuum-insulated pipes.

Accordingly, various embodiments described herein can facilitate scalable thermal energy recycling of cryogenic systems, by coupling a thermal battery to such cryogenic systems. In various aspects, the thermal battery can be considered as storing at least some thermal work that was previously performed by a cryogenic system in a previous warm-up cycle or cool-down cycle, and such stored thermal work can be dispensed by the thermal battery, so as to reduce costs (e.g., time, inputted electrical energy) needed to perform a subsequent cool-down cycle or warm-up cycle. Thus, various embodiments described herein certainly constitute concrete and tangible improvements in the field of cryogenic systems.

Although the herein disclosure mainly describes a single cryostat (e.g., 102) being coupled to a thermal battery (e.g., 104), this is a mere non-limiting example for ease of illustration and explanation. In various aspects, any suitable number of cryostats (e.g., two or more cryostats, at least one cryostat) can be coupled to any given thermal battery.

The herein disclosure describes non-limiting examples of various embodiments of the subject innovation. For ease of description or explanation, various portions of the herein disclosure utilize the term “each” when discussing various embodiments of the subject innovation. Such usages of the term “each” are non-limiting examples. In other words, when the herein disclosure provides a description that is applied to “each” of some particular object or component, it should be understood that this is a non-limiting example of various embodiments of the subject innovation, and it should be further understood that, in various other embodiments of the subject innovation, it can be the case that such description applies to fewer than “each” of that particular object or component.

The flowcharts and structures in the Figures illustrate the architecture, functionality, and operation of possible implementations of systems, methods, devices, or computer program products according to various embodiments described herein. In this regard, each block in the flowcharts can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the flowchart illustrations, and combinations of blocks in the flowchart illustrations, can be implemented by special purpose hardware-based systems that perform the specified functions or acts or carry out combinations of special purpose hardware and computer instructions.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter described herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

What has been described above includes mere examples of systems, methods, devices, or apparatuses. It is, of course, not possible to describe every conceivable combination of components or method acts for purposes of describing the one or more embodiments, but one of ordinary skill in the art can recognize that many further combinations or permutations of the one or more embodiments are possible. Furthermore, to the extent that the terms “includes,” “has,” “possesses,” and the like are used in the detailed description, claims, appendices or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A system, comprising:
at least one cryostat; and
a thermal battery coupled to the at least one cryostat by a thermal exchange system, wherein the thermal battery is configured to store thermal energy extracted from the at least one cryostat or to supply thermal energy to the at least one cryostat.

2. The system of claim 1, wherein the thermal battery is thermally insulated, by a vacuum chamber, by a heat shield, or by underground installation, from an ambient environment surrounding the at least one cryostat.

3. The system of claim 1, wherein the at least one cryostat is colder than the thermal battery, and wherein the thermal exchange system is configured to circulate a thermal exchange fluid between the at least one cryostat and the thermal battery, which circulation is configured to cause the thermal exchange fluid to absorb energy from the thermal battery and to deposit the energy to the at least one cryostat.

4. The system of claim 3, wherein the at least one cryostat is below five Kelvin.

5. The system of claim 1, wherein the at least one cryostat is warmer than the thermal battery, and wherein the thermal exchange system is configured to circulate a thermal exchange fluid between the at least one cryostat and the thermal battery, which circulation is configured to cause the thermal exchange fluid to absorb energy from the at least one cryostat and to deposit the energy to the thermal battery.

6. The system of claim 5, wherein the at least one cryostat is at room temperature.

7. The system of claim 1, wherein the thermal battery comprises a plurality of thermally insulated cells that are respectively coupled to the at least one cryostat via a plurality of actuatable flow valves of the thermal exchange system.

8. The system of claim 7, wherein the plurality of actuatable flow valves are configured to operate alternately, such that at most one of the plurality of thermally insulated cells is thermally coupled to the at least one cryostat at a time.

9. The system of claim 7, wherein two or more of the plurality of thermally insulated cells have different masses or different heat capacities than each other.

10. The system of claim 7, wherein the cryostat houses a quantum processor.

11. A method, comprising:
opening, via one or more controllers, one or more first flow valves of thermal exchange plumbing, wherein the thermal exchange plumbing couples a cryostat to a thermal battery, and wherein a first cell of the thermal battery is thermally integrated with the cryostat when the one or more first flow valves are open; and
circulating, via a pump and through the thermal exchange plumbing, a thermal exchange fluid between the cryostat and the first cell, until a temperature of the cryostat is within a threshold margin of a temperature of the first cell.

12. The method of claim 11, further comprising:
in response to a determination that the temperature of the cryostat is within the threshold margin of the temperature of the first cell, ceasing, via the pump, circulation of the thermal exchange fluid between the cryostat and the first cell; and
closing, via the one or more controllers, the one or more first flow valves of the thermal exchange plumbing, wherein the first cell of the thermal battery is thermally isolated from the cryostat when the one or more first flow valves are closed.

13. The method of claim 12, further comprising:
in response to closing the one or more first flow valves, opening, via the one or more controllers, one or more second flow valves of the thermal exchange plumbing, wherein a second cell of the thermal battery is thermally integrated with the cryostat when the one or more second flow valves are open; and
circulating, via the pump and through the thermal exchange plumbing, the thermal exchange fluid between the cryostat and the second cell.

14. The method of claim 13, wherein the first cell and the second cell have different masses or different heat capacities.

15. The method of claim 11, wherein the temperature of the cryostat is below the temperature of the first cell, such that circulation of the thermal exchange fluid between the cryostat and the first cell causes the cryostat to be heated and the first cell to be cooled.

16. The method of claim 11, wherein the temperature of the cryostat is above the temperature of the first cell, such that circulation of the thermal exchange fluid between the cryostat and the first cell causes the cryostat to be cooled and the first cell to be heated.

17. A device, comprising:
a thermal battery suspended in a vacuum chamber; and
thermal exchange plumbing that couples the thermal battery to an exterior of the vacuum chamber.

18. The device of claim 17, wherein the thermal battery comprises a spherical mass of copper.

19. The device of claim 17, wherein the thermal battery comprises at least two cells, and wherein the at least two cells have different masses or different heat capacities than each other.

20. The device of claim 17, wherein the thermal exchange plumbing comprises vacuum-insulated pipes.
